(19) United States
(12) Patent Application Publication
(10) Pub. No.: US 2011/0161112 A1
(43) Pub. Date: Jun. 30, 2011

(54) MEDICAL DATA STORAGE SERVER

(75) Inventors: Gary Keefe, Brecksville, OH (US); Richard M. Edwards, Akron, OH (US); Alan J. Gilbert, Hudson, OH (US); Christopher M. Tainer, Strongsville, OH (US); Aaron A. Bauman, Smithville, OH (US); Jeffrey L. Spencer, Cuyahoga Falls, OH (US); Ross Goodman, Solon, OH (US); Garvin Seto, Highland Heights, OH (US); Stephen N. Mucher, Cleveland, OH (US); Gary W. Enos, Hudson, OH (US); Michael Langan, South Chatham, MA (US)

(73) Assignee: CODONICS, INC., Middleburg Heights, OH (US)

(21) Appl. No.: 12/955,874

(22) Filed: Nov. 29, 2010

Related U.S. Application Data
(60) Provisional application No. 61/264,784, filed on Nov. 27, 2009.

(51) Int. Cl. G06Q 50/00

(52) U.S. Cl. 705/3

(57) ABSTRACT

Provided is a method of documenting a medical procedure including receiving medical data captured during the medical procedure to be documented. Information indicative of an identity of at least one of a patient that is a subject of the medical procedure and a physician involved with the medical procedure is received. The medical data is stored in a non-transitory computer readable medium associated with the at least one of the patient and the physician. Access to the medical data stored on the computer readable medium is restricted, allowing the physician involved with the medical procedure to subsequently retrieve the medical data stored in the computer readable medium and view the medical data retrieved. Restricting access to the recorded medical data prevents another physician, who may not have been involved in the medical procedure, from viewing the medical data without first entering information indicative of authorization to view the medical data.

### CROSS-REFERENCE TO RELATED APPLICATIONS

This application claims the benefit of U.S. Provisional Application No. 61/264,784, filed Nov. 27, 2009, which is incorporated in its entirety herein by reference.

### BACKGROUND OF THE INVENTION

1. Field of the Invention

This application relates generally to a server for storing medical data and, more specifically, to a storage server or other computer terminal and method for storing medical data to be accessed remotely and optionally automatically routed to a desired storage destination other than the storage server or other computer terminal.

2. Description of Related Art

Conventionally, medical image data captured at a health care provider's facility has been archived for long-term storage in a Picture Archiving and Communication System (“PACS”) storage location. As the medical image data is captured, the medical image data is transmitted from a medical modality over a communication network to be stored in the PACS. However, transmitting all captured medical image data to the PACS for long-term storage often results in the unnecessary, or undesirable long-term storage of medical image data. For example, a physician may be interested in only a few slices from a thin-slice CT scan, but all slices are sent to the PACS for storage. Due to the large amount of memory required to store such data, a significant portion of the PACS' storage capacity may be consumed by medical image data that would not have been manually selected for long-term storage. Further, transmitting all medical image data captured by a medical modality or other medical data capturing device creates a large amount of data traffic over a communication network connecting such a device to the PACS.

### BRIEF SUMMARY

Accordingly, there is a need in the art for a storage device for storing, at least temporarily, medical video data or other captured medical data before committing such medical data to a long-term storage location.

According to one aspect, the subject application involves a method of documenting a medical procedure including receiving medical data captured during the medical procedure to be documented. Information indicative of an identity of at least one of a patient that is a subject of the medical procedure and a physician involved with the medical procedure is received. The medical data is stored in a non-transitory computer readable medium associated with the at least one of the patient and the physician, optionally in compliance with a medical data formatting standard such as the DICOM standard. Access to the medical data stored on the computer readable medium is restricted, allowing the physician involved with the medical procedure to subsequently retrieve the medical data stored in the computer readable medium and view the medical data retrieved. Restricting access to the recorded medical data prevents another physician, who may not have been involved in the medical procedure, from viewing the medical data without first entering information indicative of authorization to view the medical data.

According to another aspect, the subject application involves a method including serving or otherwise transmitting the medical data stored by the computer readable medium over the communication network to be reproduced by a presentation device that is remotely located and external to the medical procedure area for an audience, which may include a physician or other personnel not involved in the medical procedure documented. Contextual information can optionally also be transmitted with the recorded medical data to be presented to the audience with the medical data. Examples of such contextual information include at least one of: a patient name, location of the medical procedure, a current time of the medical procedure, a date of the medical procedure, a start time of the medical procedure, an identification of the physician involved with the medical procedure, an indication of a nature of the medical procedure, and a progress indicator.

According to another aspect, recorded medical data transmitted over a communication network to be viewed by an audience can optionally also include content for generating an overlay to shield a portion of the medical data from view by the audience. The overlay can include a computer-generated image that conceals the portion of the medical data from view. This computer-generated image can optionally not be embedded in the medical data stored in the non-transitory computer readable medium, but imposed over the reproduced medical data to obscure from view by the audience portions of the medical data being reproduced. The position of the overlay can optionally be adjustably by an operator authorized to view all of the medical data, including that which is to be obscured by the overlay. To further protect privacy, information such as a patient's name or other identifying information can optionally be excluded from the medical data to be reproduced or otherwise obscured from view to maintain the patient's privacy.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is an illustrative embodiment of a medical network comprising a storage server operatively connected to a plurality of expansion modules;

FIG. 2 is a front view of an illustrative embodiment of a storage server with a front panel in an open position;

FIG. 3 is a rear view of an illustrative embodiment of a storage server, wherein a portion of a rear panel including a plurality of input/output ports is enlarged;

FIG. 4 is an illustrative embodiment of a DICOM Station Identification interface;

FIG. 5 is an illustrative embodiment of a DICOM Station Import interface;

FIG. 6 is an illustrative embodiment of a DICOM Station Export interface;

FIG. 7 is an illustrative embodiment of an administrative user interface launched by an application stored on a Smart Drive that is to be plugged into a storage server to update administrative and optionally routing settings of the storage server;

FIG. 8 is an illustrative embodiment of a summary interface launched by an application stored on a Smart Drive that is to be plugged into a storage server to update administrative and optionally routing settings of the storage server, the summary interface providing a summary of existing routing rules programmed into the storage server;

FIG. 9 is an illustrative embodiment of a rule criteria interface launched by an application stored on a Smart Drive that is to be plugged into a storage server to update administrative and optionally routing settings of the storage server, the rule criteria interface providing a plurality of fields in which the user can input criteria for automatically routing medical output received by the storage server;

FIG. 10 is an illustrative embodiment of a destination interface launched by an application stored on a Smart Drive that is to be plugged into a storage server to update administrative and optionally routing settings of the storage server, the destination interface including a plurality of destination selection menus from which a user can select one or more storage destinations from where the storage server is to automatically route medical output;

FIG. 11 is an illustrative embodiment of a base system summary interface providing an overview of a status of various components associated with a storage server that is not operatively connected to any expansion modules;

FIG. 12 is an illustrative embodiment of an expanded system summary interface providing an overview of a status of various components associated with a storage server that is operatively connected to a plurality of expansion modules;

FIG. 13 is an illustrative embodiment of an operating room equipped with a plurality of cameras for capturing video data to be received by a storage server and optionally transmitted over a communication network to be displayed;

FIG. 14 shows an illustrative embodiment of a medical network for processing digital video data;

FIG. 15 shows an illustrative embodiment of a viewing station presenting video data and a plurality of logical screens to conceal portions of the video data be presented from view; and

FIG. 16 is a block diagram showing an illustrative embodiment of a storage server and expansion module.

### DETAILED DESCRIPTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

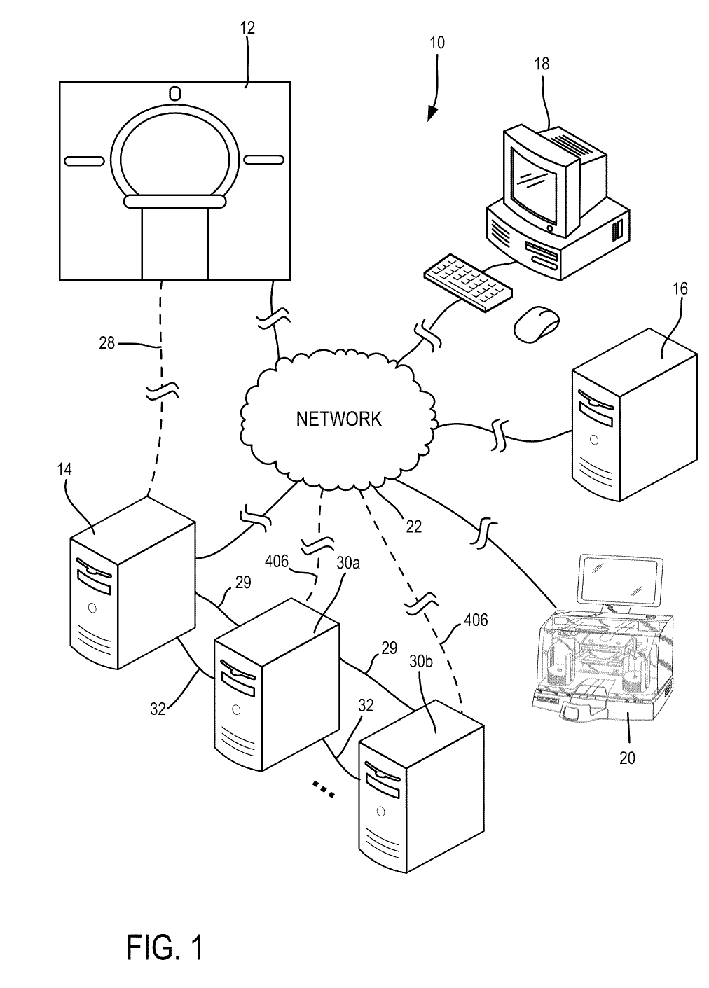

FIG. 1 shows an illustrative embodiment of a medical imaging network 10 including a medical modality, represented in FIG. 1 is a MRI 12, for capturing medical images of patients. A DICOM-compliant storage server 14 is also provided to the medical network 10 for storing the medical images. A second storage server 16, a 3-D imaging workstation 18 and a portable computer-readable-medium publisher 20 are each also included in the medical imaging network 10. Switches, routers, hubs, modems, communication transmission lines and any other conventional networking equipment for implementing networks such as a local area network (“LAN”), wide area network (“WAN”) such as the Internet, or a combination thereof, are included in the communication network 22. According to alternate embodiments, local point-to-point connections can optionally be considered a communication network such that the storage server 14 is locally connected to a medical data recording device such as a medical modality 12, video camera, endoscope, etc. . . . , for example, via a point-to-point communication link such as a USB cable, for example. According to alternate embodiments, the communication network can include any combination of the foregoing embodiments.

Although the modality is shown as a MRI 12 in FIG. 1, the one or more medical modalities can be any device for capturing medical images, audible sounds, video images, signals such as heart rates, or any combination thereof from patients. The output from the one or more medical modalities will be referred to herein generally as “medical output.” The 3-D imaging workstation 18 can be a general purpose computer provided with medical imaging viewers capable of interpreting and presenting the medical output to the user. The second storage server 16 provided to the medical network 10 can optionally be a long-term archiving server such as a Picture Archiving and Communication System (“PACS”) server, can optionally be another one of the storage servers 14 provided to the medical network 10 to provide redundant storage medical output and guard against the loss of such medical images in the event that the storage server 14 in FIG. 1 fails, or can be any other suitable computer accessible medium for storing medical output. The portable computer readable media publisher 20 is operable to receive medical output over the communication network 22 store the medical output onto a portable computer readable medium such as optical disc to be delivered to an intended recipient. Networked devices such as the MRI 12, 3-D imaging Station 18, second storage server 16, portable computer readable media publisher 20, and storage server 14 that are capable of creating, capturing, storing, communicating and/or receiving medical output in compliance with the DICOM standard are generally referred to herein as DICOM stations.

Medical output, also referred to herein as medical data, such as that produced by the MRI 12 or recorded by a medical data recording device as described below, for example, can optionally be transmitted to the storage server 14 over the communication network 22 to be stored on the storage server 14. The storage server 14 can optionally be located remotely from the MRI 12, and connected to the communication network 22 via any suitable connector 26 such as an Ethernet cable, wireless communication connection, a serial cable, or any other suitable connector compatible with the storage server 14 and an input to the communication network 22. According to alternate embodiments, however, the storage server 14 can be a stand-alone unit, separate from and external to the MRI 12, medical data recording device, etc. . . . , but locally connected to that MRI 12 MRI 12, medical data recording device, etc. . . . , via any suitable local connector 28 such as Ethernet cable, serial cable, wireless communication link, HDMI cable, FireWire cable, USB cable, and the like. The local connector 28 can facilitate a direct connection between the storage server 14 and MRI 12 to provide a local storage solution for medical output from the MRI 12 for healthcare providers that lack an expansive medical network 10 that includes network-connected storage solutions such as the storage server 14 and second storage server 16. Accordingly, the storage server can be an add-on feature operatively-connected to the MRI 12 in a time of need for storing medical images or other medical output in a format that is compliant with a medical imaging standard such as the DICOM standard, for example. Further, locally connecting the storage server 14 to the MRI 12 enables storage of medical output having a large file size that makes transmission of such medical output over the communication network 22 and storage of the medical output in the PACS server embodiment of the second storage server 16 problematic or impractical. Use of the local connector 28 to locally connect the storage server 14 to the MRI 12 can take the place of, or be in addition to the use of the network connector 26 to operatively connect storage server 14 to the MRI 12 and other DICOM stations over the communication network 22.

The storage server 14 is shown in FIG. 1 as being locally connected to one or a plurality of expansion modules 30a, 30b by local connectors 32 such as serial cables, parallel cables, USB cables, Ethernet cables, wireless communication links, HDMI cables, SAS cables, SATA cables, USB cables, and the like. The local connectors 32 transmit captured medical data between the storage server 14 and one or more of the expansion modules 30a, 30b. According to alternate embodiments, the local connectors 32 can optionally also transmit a power-control signal from the storage server 14 to instruct at least one of the expansion modules 30a, 30b to power up from either a dormant state or an off state, or power down to an off state. Powering up the expansion modules 30a, 30b activates the expansion modules 30a, 30b, placing them in an active, operational state where data can be written to, and read from a computer-readable medium provided to the at least one of the expansion modules 30a, 30b. Likewise, powering down the expansion modules 30a, 30b results in the expansion modules 30a, 30b being placed in a state where data can not be written to or read from the computer-readable medium provided to the at least one of the expansion modules 30a, 30b. Yet other embodiments, such as that shown in FIG. 1, include power signal connectors 29 that are separate from the local connectors 32 that conduct a power control signal from the storage server 14 to one or more of the expansion modules 30a, 30b as explained below.

Each expansion module 30a, 30b supplements the storage capacity of the storage server 14 in a manner described in detail below that allows the storage server 14 and each expansion module 30a, 30b to be controlled as a unit, as if the added storage capacity of the expansion modules 30a, 30b was implemented as original storage provided integrally within the storage server 14. However, the power-up and power-down operations of each expansion module 30a, 30b can be controlled by the storage server 14 to reduce the complexity associated with expanding the capacity of the storage server 14.

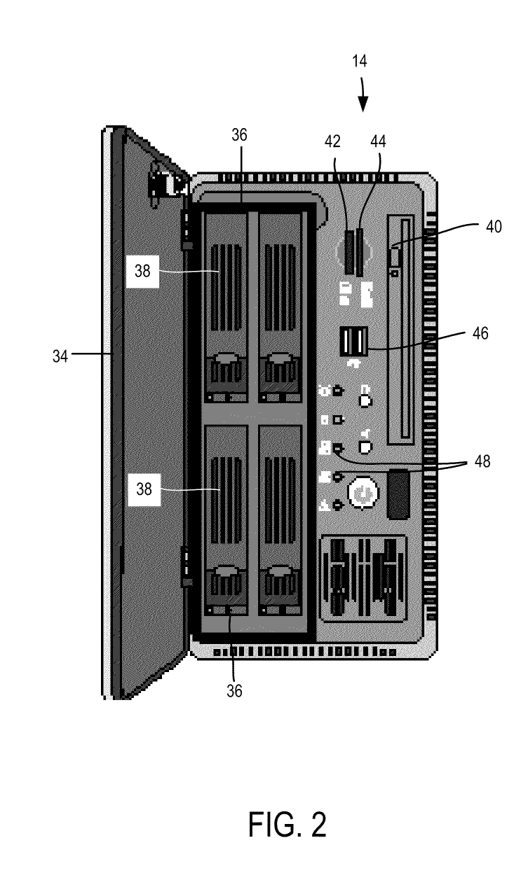

FIG. 2 shows a front view of the storage server 14 with its front panel 34 open. As shown, the storage server 14 comprises a plurality of hot-swappable drive-bays 36, each for receiving a modular hard drive unit 38 for storing medical output. Each modular hard drive unit 38 can be a magnetic computer readable medium, solid-state computer readable medium, optical computer readable medium, or any other suitable non-transitory, computer-readable storage medium, or any combination thereof. According to one embodiment, the collective storage capacity of the four hard drive units 38 provided to the storage server 14 in FIG. 2 is approximately 3 TB, 2.7 TB of which is allocated for storing medical output. The remaining 0.3 TB can be allocated for storing other electronic information such as an operating system for the storage server 14, content such as user interfaces to be served by the storage server 14 over the communication network 22 to remotely-located computer terminals, configuration parameters, and computer executable instructions controlling operation of the storage server 14, for example.

The large storage capacity of the storage server 14 makes it well suited to store large quantities of raw data from medical modalities such as the MRI 12. Conventional storage solutions operatively connected to receive medical output from the MRI 12 or other modality traditionally have not saved medical output that is 2 GB or larger in accordance with the DICOM standard. Instead, the medical output is saved as raw data that must later be converted into a DICOM compliant image. However, operators of the MRI 12 are reluctant to store this raw data in a PACS server due to the large size of the raw data. The storage server 14 can be operatively connected to the MRI 12, either locally or via the communication network 22, to store the raw data originally stored by an existing storage solution, such as a Siemens workstation for example, or can be operatively connected to the MRI 12 to store the medical output from the MRI 12 in a DICOM-compliant format without being connected to the conventional storage solution. According to one embodiment, the storage server 14 can be operatively connected to the conventional storage solution and appear in, and be accessible as an electronic folder such as a shared network folder or storage location accessible to the Siemens workstation or other convention storage solution for storing raw data from the MRI 12. The shared network folder can be location on a non-transitory computer-readable medium that is accessible over the network 22 via a network storage navigation utility such as My Computer in a Microsoft Windows environment. The shared network folder can optionally also be accessible from within other applications executed on network-connected terminals. For embodiments where the storage server 14 is operatively connected to a Siemens workstation or other conventional storage solution, the conventional storage solution can optionally be configured to automatically, without user intervention, place raw data files exceeding the 2 GB or other predetermined limit into the shared network folder representing the storage server 14 on the Siemens workstation or other conventional storage solution. According to alternate embodiments, the shared network folder can optionally be set as the default storage location for medical output received from the MRI 12. According to other embodiments, the raw data or other medical output may be required to be manually placed in the shared network folder by a technician at the Siemens workstation. Yet other embodiments include the storage server 14 retrieving medical output received by the Siemens workstation and placing it in the shared network folder.

Regardless of how the medical output ends up in the shared network folder representing the storage server 14, the storage server 14 can, in response to receiving the medical output in the shared network folder on the Siemens workstation, automatically store the received medical output in a predetermined location on the storage server 14. For example, the storage server 14 can store the received medical information in an alphabetically arranged folder corresponding to the patient's last name stored on the one or more hard drive units 38. Information about the patient, such as an initial or other portion of the patient's name can be received from the conventional storage solution or MRI 12, depending on the embodiment, as part of the transmission of medical output. In such instances, the storage server 14 can also optionally store the received medical output within a subfolder under the alphabetized folder for further organization, the subfolder corresponding to the last name of the patient. To facilitate the storing of the medical output in the appropriate folder on the storage server 14 corresponding to the patient's last name, patient names expressed using Japanese symbolic characters can optionally be converted to English other alphabetic characters. The medical output received in this manner and stored at the predetermined location on the storage server 14 can be converted into a DICOM-compliant image.

An optical computer readable medium drive 40 can also be seen in the front view of FIG. 2 for receiving a disk such as a CD or DVD storing medical output to be stored on one or more of the hard drive units 38. Other interfaces for receiving computer readable media storing medical output to be stored on a hard drive unit 38 provided to the storage server 14 can optionally include an SD card reader 42, a compact flash card reader 44, one or more USB ports 46, or any other desired input, or any combination thereof. A bank of status-indicating lights 48 is also provided to the front of the storage server 14.

In addition to the medical output, one or more of the hard drive units 38, or optionally another computer-readable memory provided to the storage server 14, can store computer-executable instructions. The computer-executable instructions, when executed by a processor provided to the storage server 14, form a server component that is operable to serve medical output stored on one or more of the hard drive units 38 or the communication network 22 to a selected DICOM station or other recipient computer terminal as described in detail below.

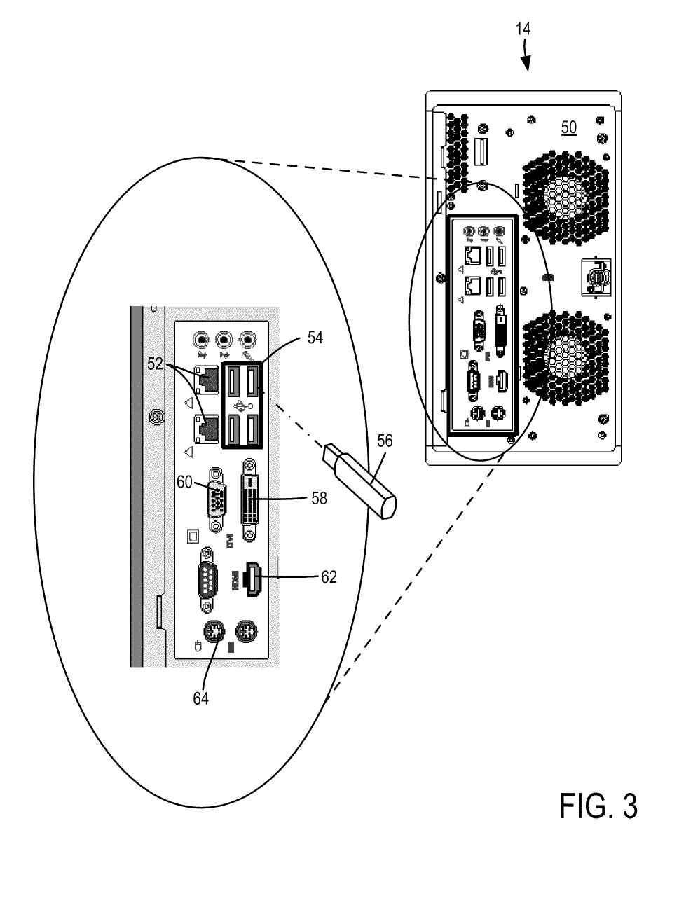

FIG. 3 shows an embodiment of a rear panel 50 of the storage server 14 with a region of the rear panel 50 comprising various input and output ports magnified. The rear panel 50 shown in FIG. 3 includes a pair of Ethernet network connection ports 52 for operatively connecting the storage server 14 to the communication network 22. An array of USB ports 54 allows for local connector 28 in the form of USB cables to be used to locally connect the storage server 14 to the MRI 12 or any other computer terminal equipped with medical output presentation software for presenting medical output to a user. The USB ports 54 are also compatible to receive a solid-state flash memory such as a USB jump Drive, referred to herein as a Smart Drive 56, storing information to be used for configuring the storage server 14. A DVI port 58, VGA port 60 and a HDMI Port 62 can optionally be provided to the storage server 14 to facilitate local connections between the storage server 14 and a computer monitor or a display device, or any other device to which a local connection is desired. Similarly a mouse port 64 can also be provided to the rear panel 50 to facilitate the connection of an input peripheral commonly referred to as a mouse.

The arrangement of the medical network 10 shown in FIG. 1 is a common network and/or local implementation of the storage server 14 for storing medical output. To enable the storage server 14 to communicate with the other network connected DICOM stations the storage server 14 is to be configured with identifying information for each of the DICOM stations. To facilitate configuration of the storage server 14, a user can log into the storage server 14 using Remote Desktop Connection client software on a computer terminal such as the 3-D imaging workstation 18 for example. According to alternate embodiments, a user can log into the storage server 14 by entering an appropriate URL into the address field of a conventional web browser to be directed to a website granting restricted access to the storage server 14 over the Internet. According to alternate embodiments, the storage server 14 can optionally support access thereto via both the Remote Desktop Connection and web access via a website.

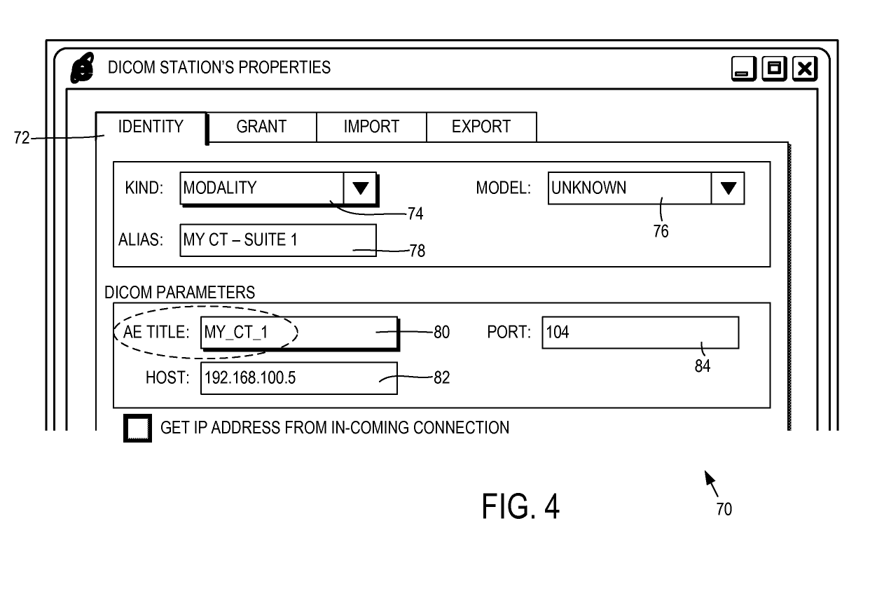

Regardless of how the storage server 14 is accessed, once the user is logged in the server component of the storage server 14 serves content over the communication network 22 to present the user with a DICOM station interface 70 such as that shown in FIG. 4. Under the “Identification” tab 72 the user is presented with a drop-down menu 74 comprising a plurality of different entries corresponding to different kinds of DICOM stations. For the example shown in FIG. 4, the kind of DICOM station being added to the database of the DICOM stations known to the storage server 14 is a medical modality. A pulldown menu 76 of models is currently set to unknown, indicating that the user does not know the exact model of medical modality being added. An alias that can be used to quickly reference this DICOM station can be added as free text in field 78.

In addition to the identifying information about each DICOM station, the identification tab 72 requires entry of DICOM-specific parameters for each DICOM station. Such parameters are specified by the DICOM standard, and are unique to the DICOM standard to ensure accurate, reproducible and reliable transmission and storage of medical output. One such parameter is an Application-Entity Title (“AE Title”) of the DICOM station entered into the AE Title field 80. The AE Title is an identifier used by DICOM stations to identify the other DICOM stations participating in a communication. Each party to a DICOM communication has an AE title. The AE Title of an initiator of the communication is referred to as a calling AE Title, while the AE Title of the intended acceptor of the communication is referred to as a called AE Title. A network address of the DICOM station is also entered into a host field 82, while a port number of the communication port of the DICOM station used for the communication is entered into a port field 84.

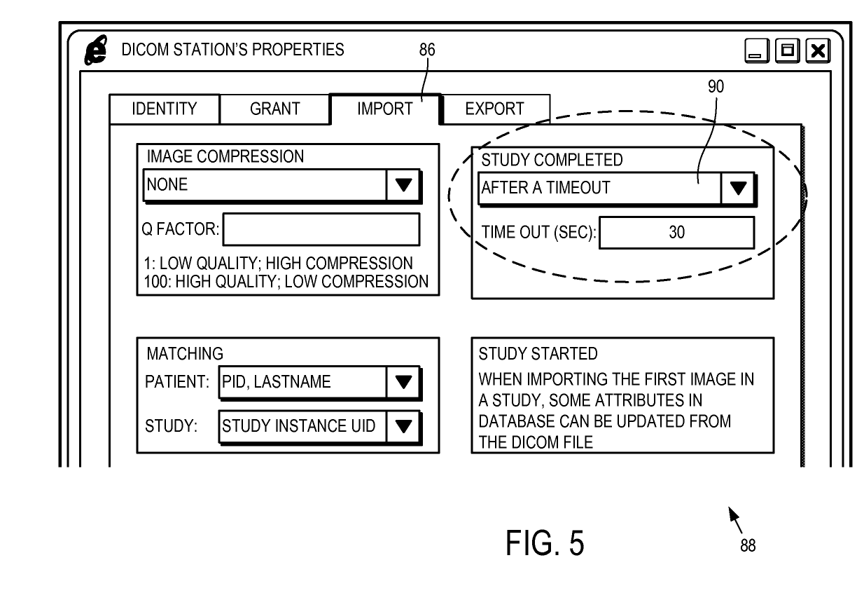

Transmissions according to the DICOM standard also make use of a confirmation that a study or other medical output being transmitted is successfully received by the recipient. Under the “Import” tab 86 shown in the user interface 88 served from the storage server 14 appearing in FIG. 5, the user is permitted to specify a form of confirmation that is to be used for communications between that DICOM station and the storage server 14 to indicate that a study or other medical output has been successfully and completely received. For the user interface 88 shown in FIG. 5, the user can select one of a plurality of different completion indicators from a pulldown menu 90. The selection chosen in FIG. 5 is expiration of a timeout lasting 30 seconds. However, other options can include “not automatically”, meaning that a study being transmitted must be manually marked as having been completed by the transmitting party. Another option for indicating the completion of a transmission can include the closing of a DICOM association between the storage server 14 and the DICOM station from which the medical output is transmitted. Closing of the association means that the communication session between the storage server 14 and the DICOM station such as the MRI 12 is concluded by a closing statement issued by the transmitting party. When this option is selected, the storage server 14 can recognize complete receipt of a study upon receiving the closing statement from the transmitting DICOM station. Yet another embodiment includes detecting completion when a so-called “Storage Commit” operation is performed. The storage-commit option utilizes a request for confirmation transmitted by the transmitting DICOM station to signal the successful receipt of the entire medical output being transmitted. Another option that can be selected is the marking of the Modality Performed Procedure Step (“MPPS”) as having been completed. Any of the above options, or any other suitable signals that can be recognized by the storage server 14 can be input or selected via the pulldown menu 90 to indicate completion of a transmission of medical output to the storage server 14.

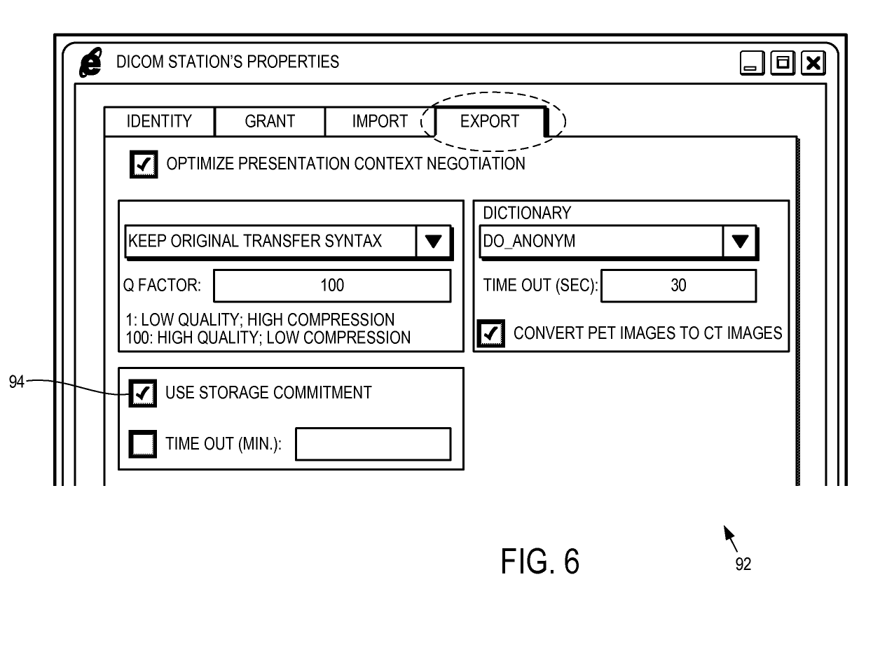

The user interface 92 shown in FIG. 6 also permits the user to configure the parameters governing the exporting of information from the storage server 14 to a recipient DICOM station such as the 3-D imaging workstation 18. For example, a checkbox 94 can be selected by the user to have the storage server 14 request confirmation of receipt from a recipient DICOM station once the storage server 14 has completed transmitting the medical output to that recipient DICOM station.

In addition to configuring the storage server 14 to recognize each DICOM station with which it will communicate, the storage server 14 is also to be configured for administrative purposes, and for optionally routing medical output delivered to the storage server 14 to an ultimate storage destination. To configure the storage server 14 and established the administrative and optional routing settings, a user can install the Smart Drive 56 shown in FIG. 3 into an available USB port 54. A configuration application is stored on the Smart Drive 56 for updating the administrative and optional routing settings of the storage server 14 when the Smart Drive 56 is plugged into the storage server 14. In response to installation of the Smart Drive 56 into the USB port 54, the configuration application is launched to update the administrative and optional routing settings of the storage server 14 with the corresponding settings saved on the Smart Drive 23. According to an alternate embodiment, launching of the configuration application can optionally occur automatically through operation of an autorun feature in response to insertion of the Smart Drive 23 into the USB port 54, without additional user intervention subsequent to insertion of the Smart Drive 23.

Storing the configuration application on the Smart Drive 56 enables users to establish the administrative settings and optional routing settings using any general purpose computer with a USB port. Then, a user can update the administrative and optional routing settings of the storage server 14 simply by plugging the Smart Drive 56 into the USB port 54 of the storage server 14. This can be repeated for each storage server 14 to be updated, but each Smart Drive 56 can optionally be required by the storage server 14 to be present in the USB port 54 in order for the storage server 14 to be operable. Thus, although a single Smart Drive 56 can be inserted into a USB port 54 of a plurality of different storage servers 14 to update the administrative and optional routing settings thereof, the Smart Drive 56 remains in the USB port 54 of the storage server 14 that is to be operational. The other storage servers 14 are not operational without the Smart Drive 56 installed in their USB ports 54, although their administrative and optionally routing settings have been updated.

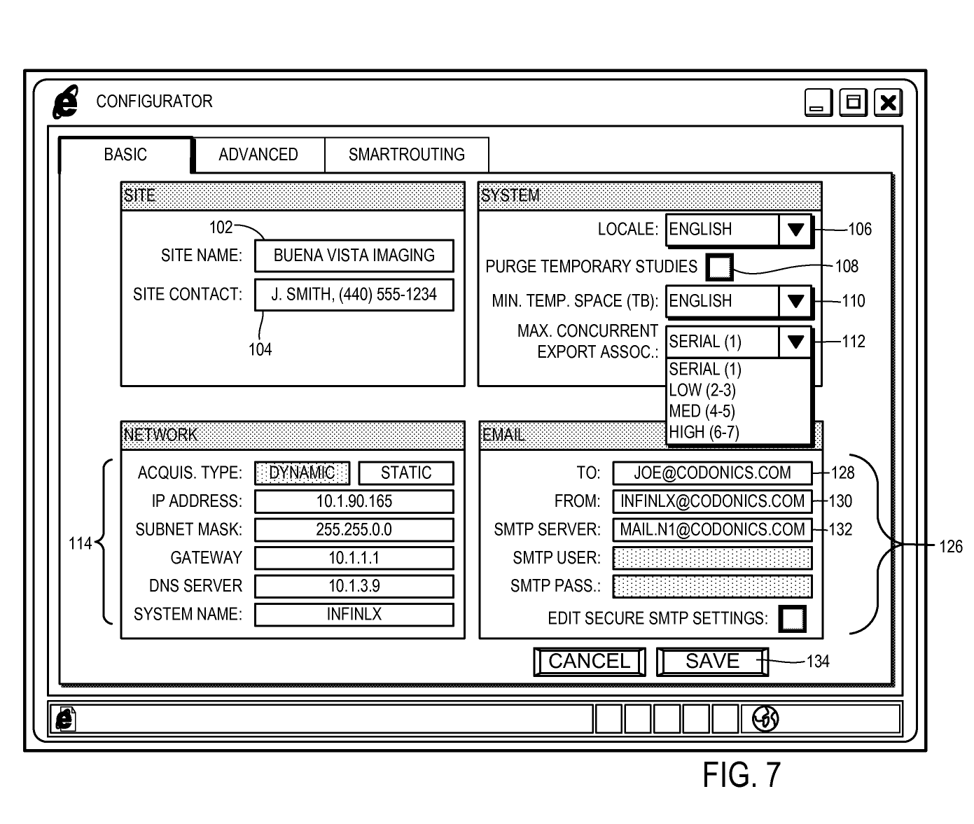

According to alternate embodiments, the Smart Drive 56 can be assigned a serial number specific to a single storage server 14, and can only be used to update the administrative and optional routing settings of that single storage server 14. Only the storage server 14 corresponding to the serial number on the Smart Drive 56 can be updated using that particular Smart Drive 56 according to such embodiments. For example, a user can insert the Smart Drive 56 into a USB port of the 3-D imaging workstation 18 in FIG. 1 or any available general purpose computer with a USB port available to receive the Smart Drive 56. With the Smart Drive 56 inserted a folder can be opened, either automatically via the optional auto run feature or manually by the user, to reveal the contents of the Smart Drive 56, including the configuration application. The configuration application can be launched to present the user of the 3-D imaging Station 18 with the user interface 100 shown in FIG. 7. Within the user interface 100 the user can use free text entry to input the location at which the storage server 14 is to be deployed in field 102 as well as a contact at that location who can be reached to address any issues with the storage server 14 in field 104.

The user interface 100 also includes options to establish basic working parameters of the storage server 14. For example, the language of users (and how the language of the database is set) of the storage server 14 can be selected from pull down menu 106. Additionally, various options relating to the temporary storage of medical output by the storage server 14 can be selected. Examples of these parameters include a checkbox 108 that can be selected to cause the storage server 14 to delete, or at least mark for deletion, medical output that was temporarily stored by the storage server 14. A portion of the collective storage capacity of the storage server 14 can be dedicated in field 110 for the storage of such temporary medical output files. The user can specify using another pull down menu 112 a maximum number of concurrent export associations involving the storage server 14 that can be open at any given time. The user may elect to select a maximum number of concurrent export associations based on the bandwidth available to the storage server 14 for exporting to medical output.

The user interface 100 also includes various network specific fields 114 that can be specified by the user to uniquely identify the storage server 14 within the particular medical network 10 the storage server 14 forms a part of. Among the network specific fields 114 shown in FIG. 7 are included an IP address field 116, a subnet mask field 118, a gateway address field 120, a domain name server address field 122, and a system name field 124 in which the network name of the storage server 114 can be specified. The network specific fields 114 shown in FIG. 7 are to be utilized by users attempting to remotely access the storage server 14 using DICOM stations or other network-connected clients. It also puts the storage server 14 on the network in order to store studies from a DICOM host to the storage server 14 as well as allow studies to be exported from the storage server 14 to a DICOM destination.

The user interface 100 also includes contact information 126 that can be used by the storage server 14 to automatically issue an alert regarding the status of the storage server 14, or a portion thereof. The contact information 126 can also optionally be used to deliver an alert to an administrator regarding the status of any portion of the medical network 10 that may be interfering with proper operation of the storage server 14. The contact information specified within the user interface 100 can optionally be entered into one or more of a destination e-mail address field 128 for specifying the e-mail address to which alerts should be sent, a source e-mail address field 130 or other identifier field indicating the source of e-mails transmitted to the administrator, and an outbound e-mail server field 132 from which outbound alert e-mails to the administrator to be sent.

The storage server 14 is not limited to only transmitting an alert in response to a fault or other undesirable condition that has already occurred. Alerts can be transmitted by the storage server 14 to the specified administrator via the contact information 126 in response to detecting a condition that could potentially lead to a fault or other undesirable condition. For example if a sensed temperature to which the storage server 14 is exposed exceeds a predetermined level but is less than a maximum allowable temperature, the storage server 14 can optionally transmit an alert indicating such a condition before the sensed temperature reaches the maximum allowable temperature. Likewise, the storage server 14 can detect a condition where the available free storage capacity of the hard drive units 38 falls below a predetermined level and transmit the corresponding alert to the administrator indicating the existence of such a condition before all of the storage capacity is used. For instance, if the available free storage capacity of the hard drive units 38 falls below 20% of the collective storage capacity of the hard drive units 38, a corresponding alert can be transmitted by the storage server 14 indicating an impending shortage of storage capacity.

Instead of, or in addition to using e-mail to transmit alerts from the storage server 14 to administrator, an alert application such as RSS feed for example, can be installed on a computer terminal, such as 3-D imaging workstation 18 for example, that is network connected to the storage server 14 via the communication network 22. The alert application can be operable in a manner similar to an antivirus application upon detection of malware, wherein an alert window can be automatically generated to appear on the computer monitor provided to the 3-D imaging workstation 18 in response to receiving an alert signal from the storage server 14 (for embodiments where the alert application is RSS feed, RSS feed is provided on the storage server 14 to transmit the alerts to be displayed to the user using Remote Desktop Connection). Thus, even if an e-mail application is not operable on the 3-D imaging workstation 18, a user thereof can be alerted to the existence of a condition leading to the transmission of the clerk by the storage server 14. According to alternate embodiments, text messages can be transmitted to be delivered on a cellular telephone device, or any other method of transmitting an alert to an administrator can be utilized.

Selecting a save button 134 in the user interface 100 stores the information entered into the various fields of the user interface 100 within the Smart Drive 56 connected to the 3-D imaging workstation 18. To update the storage server 14 the Smart Drive 56 must be delivered to and plugged into one of the USB ports 54 provided to the storage server 14 corresponding to the serial number assigned to the Smart Drive 56. As mentioned above, if so configured, the auto run feature can automatically begin execution of computer executable instructions stored on the Smart Drive 56 and or on the storage server 14 to update the information in the storage server 14 to reflect the information saved to the Smart Drive 56 via the user interface 100. According to alternate embodiments, updating the information on the storage server 14 with the information saved to the Smart Drive 56 can be initiated manually.

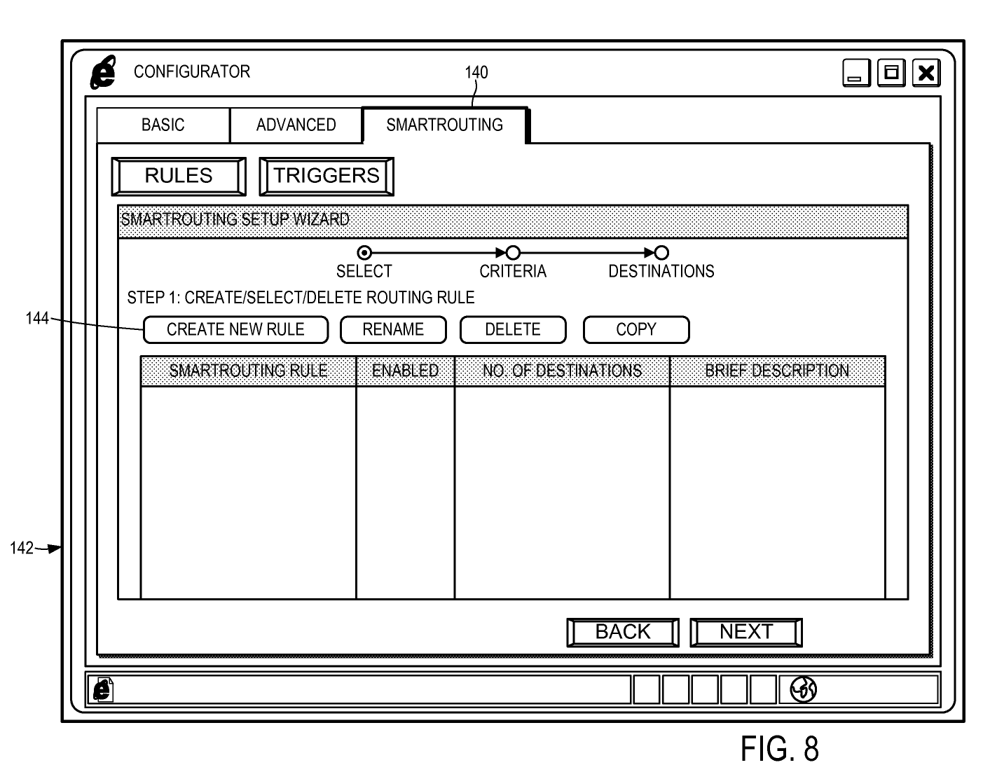

The configuration application stored on the Smart Drive 56 also includes a “SmartRouting” tab 140, shown in FIG. 8, enabling the user to specify the criteria for automatically routing medical output received by the storage server 14 to a predetermined destination. Again, updating the SmartRouting criteria under the SmartRouting tab 140 can simply update the information stored on the Smart Drive 56 if the Smart Drive is plugged into a terminal other than the storage server 14 while it is being updated. The Smart Drive 56 must once again be delivered to and plugged into the storage server 14 after the SmartRouting criteria are saved to the Smart Drive 56 and the storage system 14 rebooted for the changes to be reflected in the storage server 14.

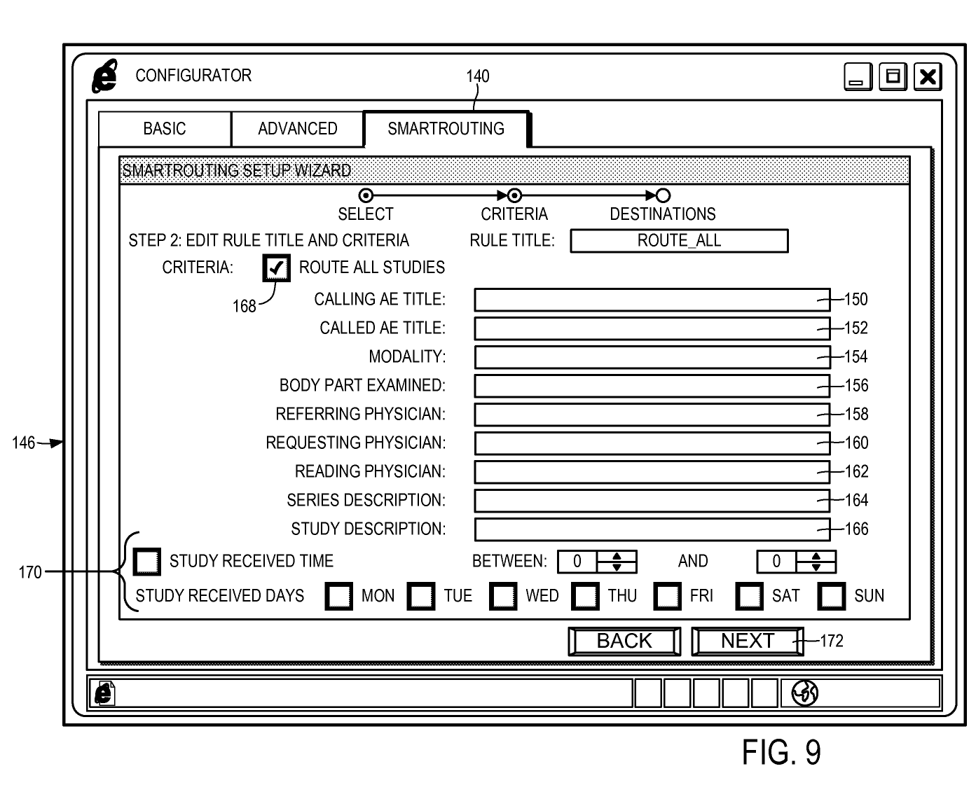

As shown in FIG. 8, the SmartRouting tab 140 includes an initial screen 142 providing an overview of the current rules in place for the storage server 14 and the status of those rules. To create a new rule the user can select the “create new rule” button 144 to advance the rule-creation process to the stage shown in the user interface 146 appearing in FIG. 9. Within the user interface 146, the user can specify the criteria to be satisfied by DICOM studies and other medical output received by the storage server 14 to be automatically routed, without user intervention, to another destination accessible via the communication network 22. The criteria that can be entered via the user interface 146 for smart routing purposes can optionally include information commonly embedded within, or otherwise accompanying medical output pursuant to the DICOM standard. For example, a calling AE Title field 150 and a called AE Title field 152 can specify the AE Title of the calling and/or called DICOM station from which, or to which, the medical output is to be automatically routed, respectively. Other examples of fields provided to the user interface 146 for entering criteria to determine whether medical output should be automatically routed from the storage server 14 to another destination include, but are not limited to: the modality field 154 specifying a medical modality, a body part field 156 for specifying a portion of the patient examined in the medical output, and a referring physician field 158, requesting physician field 160 and treating physician field 162. The physician related fields 158, 160, 162 can be used to specify various participants in the medical care provided to the patient for whom the medical output is to be automatically routed. A series description field 164 and a study description field 166 also allow descriptions of the medical output to be used as the basis for automatically routing the medical output from the storage server 14 to another destination. These examples of the criteria for automatically routing the medical output from the storage server 14 are illustrative and not exhaustive.

Any of the criteria specified by the user for automatically routing medical output must be satisfied for automatic routing to occur. Thus if a user specifies a plurality of different criteria to be used, each of the plurality must be satisfied, otherwise automatic routing of medical output will not occur.

Also included within the user interface 146 is a checkbox 168 that can be selected to cause the storage server 14 to automatically route all received medical output to another destination. Such a selection can be useful for creating a backup copy of all medical output received by the storage server 14 on another DICOM computer-accessible medium such as the second storage server 16 shown in FIG. 1, for example. Time and date criteria 170 shown in the user interface 146 of FIG. 9 can also optionally be used to determine whether medical output received by the storage server 14 should be automatically routed to another destination. The time and date criteria 170 can specify time and date ranges during which medical output received can be routed to another destination. The time and date criteria 170 can be used in addition to, or in lieu of other criteria entered via the user interface 146.

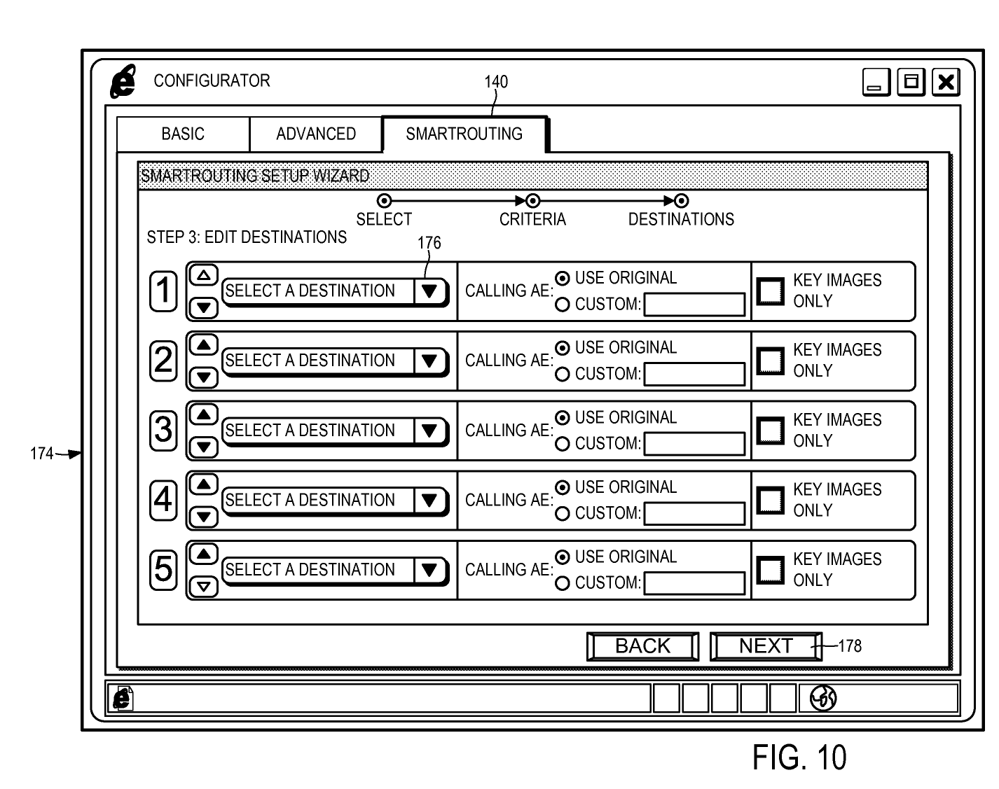

Having selected the various criteria and user interface 146, the user can select the next button 172 to advance the rule-creation process to the stage shown in FIG. 10. The user interface 174 appearing in FIG. 10 allows the user to select up to five different destinations to which the medical output satisfying the selected criteria is to be automatically routed from the storage server 14 to another storage destination. The user can select from a pull down menu 176 any of the DICOM stations configured in the storage server 14 as described with reference to FIGS. 4-6. After each desired destination has been entered by the user the user can select a save button 178 to complete the rule-creation process. The newly-saved rule is saved on the Smart Drive 56 and is automatically updated in the storage server 14 when the Smart Drive 56 is subsequently plugged into one of the USB ports 54 as described above for updating the administrative settings with reference to FIG. 7.

In use, the storage server 14 can be included in the medical network 10 as shown in FIG. 1 utilizing the network connector 26 to connect the storage server 14 to the communication network 22. Upon initially installing a storage server 14 the administrator or other authorized user can configure each DICOM station with which the storage server 14 will communicate, and then establish the administrative settings and optionally the routing settings using the Smart Drive 56 as described above.

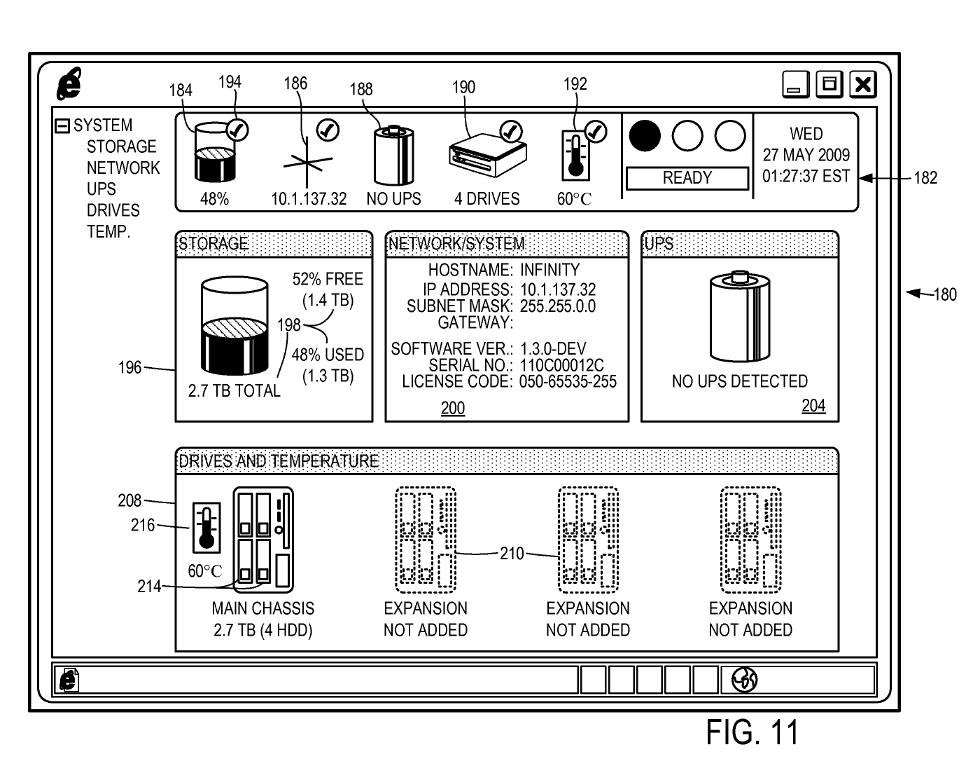

Once the storage server 14 is properly configured, a user can login to the storage server 14 using a network connected computer terminal such as the 3-D imaging workstation 18. A user interface 180, shown in FIG. 11, is served by the server component of the storage server 14 over the communication network 22 to the 3-D imaging workstation 18. The user interface 180 includes a status bar 182 comprising a general indication of the overall status of various factors affecting operation of the storage server 14. Although the factors displayed in the status bar 182 can include any factor that can affect the performance of the storage server 14, the factors whose status is shown in the status bar 182 in FIG. 11 include free storage capacity 184 of the hard drive modules 38, a network connection status 186, a backup uninterruptible power supply status, if any, a storage status 190, and a temperature status 192. A green checkmark 194 next to an icon representing one of the factors indicates that the status of the respective factor is acceptable for normal operating conditions. An absence of the checkmark 194 can indicate an undesired status, or a status other than that expected under normal operating conditions.

The user interface 180 can also include a detailed view of the storage server 14 configuration. For example, a storage summary 196 graphically illustrates a ratio of free storage capacity to used storage capacity, and also provides textual indicators 198 identifying details concerning the overall storage available to the storage server 14, and the amount that is used and available to be used.

A network/system summary 200 provides details concerning the network connection between the storage server 14 and the communication network 22, as well as details concerning the current version of software installed on the storage server 14. License code information and a serial number uniquely identifying at least one of the storage server 14, the software provided to the storage server 14, or another portion of the medical network 10 can also be provided for reference purposes. A backup uninterruptible power supply summary 204, as its name indicates, provides details concerning the status of a backup power supply, if any, connected to the storage server 14 to ensure the storage server 14 remains operational during a loss of the primary system power. For the user interface shown in FIG. 11, the backup power supply summary 204 indicates that a connection to a backup power supply does not currently exist.

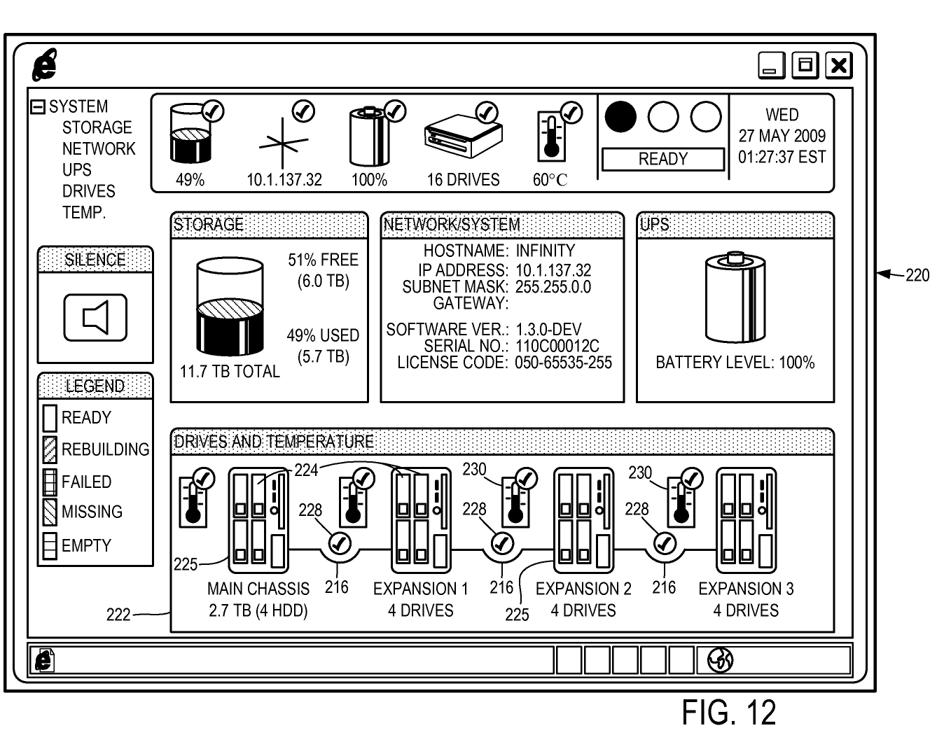

A drive and temperature summary 208 provides graphical details concerning the temperature of the storage server 14 and the total storage capacity available to the storage server 14. As shown in FIG. 11, the storage server 14 is operating by itself, without local connections to any of the expansion modules 30a, 30b shown in FIG. 1. Icons 210 representing expansion modules are grayed out indicating that no expansion modules are connected to the storage server 14. The icon 212 representing the storage server 14 and its individual hard drive units 38 in the user interface 180 is illustrated in FIG. 11 in full color. Icons 214 representing each of the hard drive units 38 provided to the storage server 14 are also shown in full color. The color of each of the icons 214 can independently vary depending upon the status of each of the hard drive units 38 represented by the icons 214 according to a color scheme shown in the legend 215 appearing in FIG. 12. A temperature icon 216 is also shown adjacent to the icon 212 representing the storage server 14 and any icons 210 representing the expansion modules 30a, 30b that are locally connected to the storage server 14 when the user interface 180 is viewed. Accordingly, the user interface can give a synopsis of the various factors affecting performance of the storage server 14.

As mentioned above with reference to FIG. 1, one or more expansion modules 30a, 30b can optionally be locally connected to the storage server 14 to increase the overall storage capacity available for storing medical output. The expansion modules 30a, 30b can optionally include the same hardware and software as the storage server 14. However, each expansion module 30a, 30b can optionally be configured using a key code that is different than the key code of the storage server 14 to designate the expansion modules 30a, 30b as supplemental storage devices to the storage server 14, instead of an independent storage server 14 itself. The key code entered into the storage server 14 and expansion modules 30a, 30b can specify the operational state of various different components thereof, and can designate each unit as a storage server 14 that can control operation of the expansion modules 30a, 30b, or as one of the subservient expansion modules 30a, 30b. Each expansion module 30a, 30b offering supplemental storage capacity to a storage server 14 can optionally be programmed and thereby activated with a different key code from other expansion module 30a, 30b also providing supplemental storage for the same storage server 14. The key code used for each expansion module 30a, 30b can optionally be sequential in order, indicating where in the chain of serial connected expansion modules 30a, 30b each expansion module 30a, 30b is located. According to such environments, the expansion modules 30a, 30b are to be connected to the storage server 14 in order of their key codes. Such a configuration can optionally be implemented according to a Serial Attached SCSI (“SAS”) protocol.

According to alternate embodiments, the expansion modules 30a, 30b can optionally have a simplified hardware and/or software architecture that renders the expansion modules 30a, 30b basic non-transitory computer-readable storage devices. In other words, unlike the storage server 14, the expansion modules 30a, 30b can include a minimal hardware and/or software sophistication for simply performing the storage of medical data under the control of the storage server 14 to which it is operatively connected. The storage server 14 can include a master computer processor 406 programmed to not only control operation of the components of the storage server 14 and the reading/writing of medical data from/to the hard drives 38, but also an expansion controller 408 for controlling the power status of, and transmission of medical data to the expansion units 30a, 30b.

Each of the expansion modules 30a, 30b can be connected in series to the storage server 14 as shown in FIG. 1. Thus, the expansion module 30a is serially connected to the storage server 14 using a suitable cable extending between SAS ports provided to the storage server 14 and the expansion module 30a. Likewise, the expansion module 30b is serially connected to the expansion module 30a also using a suitable cable extending between SAS ports provided to the expansion module 30b and the expansion module 30a. Each of the expansion modules 30a, 30b connected to the storage server 41 is independently plugged into a power supply and optionally a backup power supply. However, power management of the combined storage server 14 and expansion modules 30a, 30b connected to the storage server 14 is controlled via commands input to the storage server 41. For example, an instruction from a user to power down the storage server 14 also results in each expansion module 30a, 30b operatively connected according to the SAS protocol being powered down. Likewise, when the storage server 14 is initially powered up, each of the expansion modules 30a, 30b is also powered up as a result. Accordingly, the storage server 14 and each of the expansion modules 30a, 30b operatively connected according to the SAS protocol can function as one individual unit.

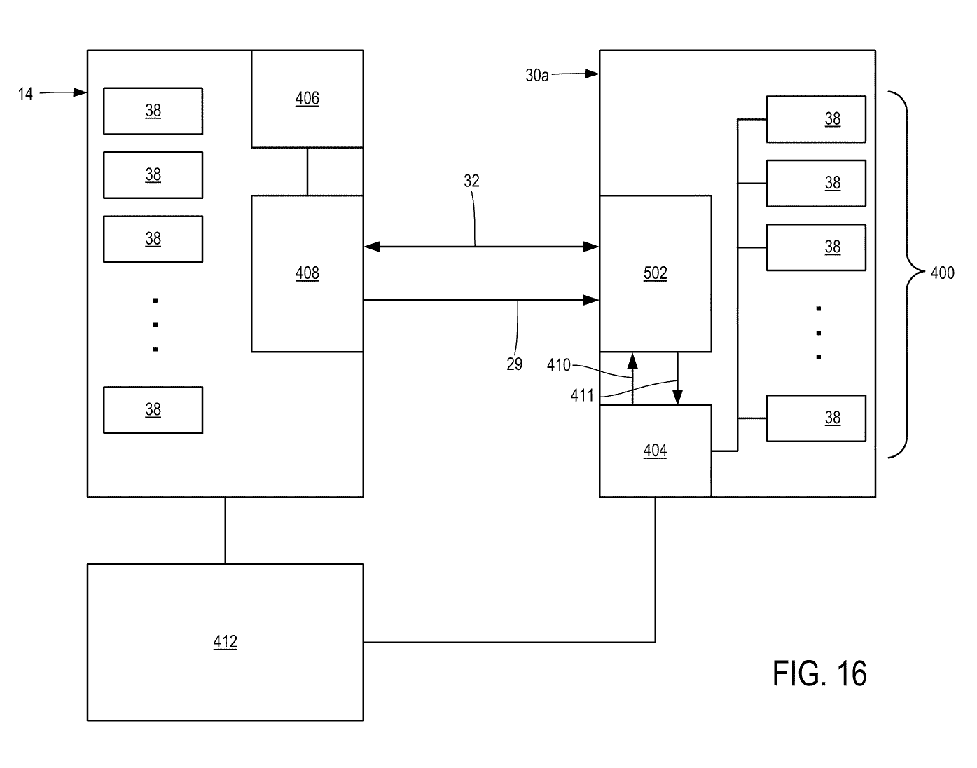

According to an embodiment shown in FIG. 16, a first expansion module 30a is operatively connected to storage server 14 via a local connector 32 in the form of a SAS connection. A communication interface module 502, such as a SAS expander module for example, contained within the expansion module 30a provides connection from the SAS input of the expansion module 30a to the RAID array 400 of hard drives 38 contained within the expansion module 30a. The combination of the SAS form of the local connector 32 and communication interface module 502 allows the storage server 14 to transmit data to be stored in the RAID drives 38 in the expansion module 30a for data storage and retrieval. Additional expansion modules can be connected to the first expansion module 30a via additional SAS connections, the connections optionally being established in series between the expansion module 30a and a subsequent expansion module 30b, such as that shown in FIG. 1. The SAS version of the local connector 32 also allows for the transmission of a power control signal from the storage server 14 to control a power supply 404 provided to the expansion module 30a to power up or power down the expansion module 30a. Thus, although the power signal connector 29 is shown separate from the local connector 32 in FIG. 16, those two connectors can optionally be integrally formed as a single connector.

According to alternate embodiments, the expansion modules 30a, 30b in FIG. 1 are connected to the storage server 14 via network connections. In other words, the optional local connectors 32 and optional power signal connectors 29 in FIG. 1 are replaced with network connectors 406 such as Ethernet cables, appearing in FIG. 1 as broken lines, and the expansion modules 30a, 30b are located remotely from the storage server 14 relative to the network 22. Again, a communication interface module 502 as shown in FIG. 16 within the expansion module 30a connects the network input to the expansion module to the RAID hard drives 38 in the expansion module 30a. For such embodiments, the communication interface module 502 can be a computer board with RAID controller capability.

As indicated above, the storage server 14 controls the powering on and off of the expansion module or modules 30a, 30b connected to the storage server 14. Any suitable protocol for controlling the power status of the expansion modules 30a, 30b with the storage server 14 can be employed, but examples of suitable protocols include, but are not limited to Software Command Control and Direct Hardware Control.

The Software Command Control example will be explained with reference to FIG. 16. Each expansion module 30a, 30b maintains the supply of a minimal power standby voltage via a power line 410 whenever a power supply 404 provided to the expansion modules 30a, 30b is plugged into an active AC mains outlet 412, even when the expansion modules 30a, 30b are in a powered down, or dormant state. The AC mains outlet 412 can optionally include an uninterruptible power supply (“UPS”) and/or surge suppression circuitry. The minimal standby power allows a communication interface module 502 to function and perform a power control action in response to receiving a power control signal transmitted by the storage server 14. The communication interface module 502 of each expansion module 30a is able to receive commands from the storage server 14 over communication link 32 and convert these commands into control signals for its own power supply 404. When the expansion module communication interface module 502 receives the command to power on, the expansion communication interface module 502 transmits a signal along communication channel 411 to signal the power supply 404 to turn on all system power voltages, thus powering on the entire expansion module 30a. Although shown separately, power line 410 and communication channel 411 can optionally be the same, or at least integrally formed together as a single connector.

When the communication interface module 502 receives the command from the storage server 14 to power off, the interface module 502 of the expansion module 30a interrogates the status of each drive 38 to determine whether medical data is being written to, or read from such drives 38. If no reading or writing operations are being performed, the communication interface module 502 signals the power supply 404 to turn the main power voltages off, thus shutting down all of the expansion module 30a except for the standby voltage which powers the communication interface module 502. If a reading and/or writing process, or other process involving any of the drives 38 is underway, the expansion module 30a delays transmission of the signal to power down the power supply 404 until such operation is complete. By this process, the storage server 14 can turn the expansion modules 30a, 30b on and off by sending commands over the communication link 32 to the communication interface module 502 included in each expansion module 30a, 30b.

In an embodiment of the invention using Software Command Control, the communication link 32 is a SAS link. The expansion module communication interface module 502 is a SAS expansion card. The storage server 14 sends power-on and power-off commands to the individual expansion modules 30a, 30b via SAS or SES protocol commands. Inside the expansion modules 30a, 30b, the SAS expansion card receives these commands and sends the appropriate control signals to the expansion module power supply to turn the supply on and off. The SAS expansion card controls the power supply via GPIO ports connected to the power enable input signals on the power supply 404.

In another embodiment employing Software Command Control, the communication link 32 can be an Ethernet link. The expansion module's communication interface module 502 can be a computer motherboard. The storage server 14 sends power-on and power-off commands to the individual expansion modules 30a, 30b via commands over Ethernet using any number of suitable Ethernet protocols known to those skilled in the art. Inside the expansion modules 30a, 30b, the motherboard receives these commands and sends the appropriate control signals to the expansion module power supply 404 to turn the supply 404 on and off. The motherboard controls the power supply via GPIO ports connected to the power enable input signals on the power supply 404.

Yet another embodiment employing Software Command Control utilizes a local connector 32 in the form of a USB link. The expansion module communication interface module 502 is accordingly a USB hub for such embodiments. The storage server 14 sends power-on and power-off commands to the individual expansion modules 30a, 30b via commands over USB and controls I/O pins on the USB hub board via techniques known to those skilled in the art. On the USB hub, the appropriate control signals are sent to the expansion module power supply 404 to turn the supply 404 on and off. Like any of the embodiments described herein, the expansion modules 30a, 30b perform a delay if a reading/writing operation is in progress when a power down command is issued by the storage server 14.

According to another embodiment employing Software Command Control, the local connector 32 can be a wireless radio link. The expansion module communication interface module 502 of such embodiments is a wireless radio link board including a radio antenna. The storage server 14 sends power-on and power-off commands to the individual expansion modules 30a, 30b via commands over the wireless link and controls I/O pins on the wireless radio link board via techniques known to those skilled in the art. On the wireless radio link board, the appropriate control signals are sent to the expansion module power supply 404 to turn the supply 404 on and off.

For embodiments that employ Direct Hardware Control, there is a hardware connection between the storage server 14 and the expansion modules 30a, 30b in addition to the data connection 32. For such embodiments, computer and/or electronic hardware techniques are used to automatically turn the expansion modules 30a, 30b on when the storage server 14 power is present and automatically turn the expansion modules 30a, 30b off when power to the storage server 14 is not present. Thus, power to the expansion modules 30a, 30b mirrors the power to the storage server 14. For any of the embodiments described herein, the storage server 14 can optionally transmit the power control signals to power up/down the expansion modules 30a, 30b automatically (i.e., without separate user intervention) in response to the receipt by the storage server 14 of a command from a user altering a power state of the storage server 14.

An embodiment of Direct Hardware Control includes the use of a power signal connection 29 in the form of a USB connection. When the storage server 14 turns on, a 5V output signal of a USB port of the storage server 14 will activate the power enable signal within the expansion module 30a, thereby turning the expansion module 30a on at the same time. For any of the embodiments, when a plurality of expansion modules 30a, 30b are present, the power control signals received by the first expansion module 30a can optionally be automatically forwarded to the subsequent expansion module 30b by the first expansion module 30a, or optionally transmitted in parallel to the expansion modules 30a, 30b by the storage server 14 to control the expansion modules 30a, 30b based on the control of the storage server 14. When the storage server 14 turns off, the 5V output of its USB ports will turn off. This will in turn deactivate the power supply enable signals of the expansion modules 30a, 30b and the expansion modules 30a, 30b will turn off. By this action, turning the storage server 14 on will automatically turn the expansion modules 30a, 30b on and turning the storage server 14 off will automatically turn the expansion modules 30a, 30b off.

In another embodiment of the invention using Direct Hardware Control, the power signal connection is a power strip or uninterruptible power supply (UPS) with a master/slave function 412. In this embodiment, when the storage server 14 turns on, the UPS or power strip 412 will sense the current draw of the storage server and will then enable mains power to the expansion modules. When the storage server turns off, the UPS or power strip 412 will sense the lack of current draw by the storage server and will then disable mains power to the expansion module or modules. By this action, turning the storage server on will automatically turn the expansion modules on and turning the storage server off will automatically turn the expansion modules off.

In this invention, the power state of the expansion module or modules 30a, 30b is controlled by the storage server. It is critical to maintain integrity of the data on the hard drives during the process of powering the units on and off. In embodiments in which Direct Hardware Control is used, the expansion modules are powered on and off concurrently with the storage server. As a result, the hard drives of the expansion module or modules become available at approximately the same time as the hard drives resident locally on the storage server. In this case, all system hard drives, whether located on the storage server or in the expansion modules are available when the storage server operating software needs to look for them. Likewise, any existing storage jobs will be completed and the data caches for the hard drives will be completely flushed by the operating software before the power is actually removed from the storage server. As a result, there is little concern for data loss during power on or power off operations when Direct Hardware Control is used.

An illustrative method of using Software Command Control to power on an expansion module 30a is as follows. The storage server 14 is powered on by the user pressing a power button at the front or other location on the storage server 14 case. The storage server 14 boots the operating software. The operating software, when ready, scans the local connector 32, and determines which expansion modules 30a, 30b are connected, if any. The presence of expansion modules 30a, 30b can be detected since the expansion modules 30a, 30b are powered by the standby power, even in a dormant state. Once the storage server 14 determines which expansion modules 30a, 30b are connected, the storage server 14 issues a command to each expansion module 30a, 30b in parallel, or to one expansion module 30a which, in turn transmits the command to a subsequent expansion module 30b in series, to power up. The storage server 14 allows sufficient time for the hard drives 38 in the expansion modules 30a, 30b to become powered on and ready. Once the drives 38 of all of the expansion modules 30a, 30b are ready, the storage server 14 can commence with normal operation, reading medical data from, and writing medical data to the drives 38 in the storage server 14 as well as the expansion modules 30a, 30b. If any of the expansion modules 30a, 30b or hard drives 38 in the expansion modules 30a, 30b are not properly detected, database corruption could ensue due the appearance of missing drives. As a result, the storage server 14 can maintain a database of all expansion modules 30a, 30b and drives 38 it expects to see when powered on and will display an error if any are missing.

An example of a power off method employing Software Command Control is as follows. The storage server 14 is commanded by the user to power off by the user pressing the power button at the front or other location on the storage server 14 case. The operating software of the storage server 14 will stop any new storage jobs from being received over the communication network 22. The operating software, when executed, will then initiate a delay of suitable duration to complete all currently pending reading/writing operations initiated prior to the issuance of the power down command. The storage server 14 will then flush any remaining data to the appropriate hard drives 38 so that no medical data is left remaining in any hard drive cache. When all hard drive data has been flushed and all drives 38 are ready to be powered down or placed in a dormant state, the storage server 14 will issue commands via local connector 32 to the expansion modules 30a, 30b commanding them to turn off main power. Each expansion module 30a, 30b receives these commands, either in parallel, in series, or sequentially, and turns off main power according to the methods described above. When the storage server 14 senses that each expansion module 30a, 30b has been turned off such that only the communication interface module 502 is powered on in each expansion module 30a, 30b, then the storage server 14 will turn itself off completing the system power down process.

According to an alternate embodiment, an expansion controller 408 in the storage server 14 is the communication port to the expansion modules 30a 30b. During power-on, the expansion controller 408 detects all connected expansion modules 30a, 30b, turns them on and then waits until all expected hard drives 38 are ready before allowing any reading/writing of medical data. In so doing, the expansion controller 408 prevents accidental omission of one or more hard drives 38 which could result in database corruption. During power down, the expansion controller 408 is to ensure that all drive caches for all expansion modules 30a, 30b are flushed before the expansion modules 30a, 30b are commanded to turn off. The expansion controller 408 then turns off the expansion modules 30a, 30b when ready. The expansion controller 408 and/or processor 406 is programmed to not rediscover any of the expansion modules 30a, 30b or hard drives 38 at this point because power down is in process. If expansion modules 30a, 30b or hard drives 38 were rediscovered at this point, data corruption could result. Once the expansion controller 408 has determined that all expansion modules 30a, 30b are turned off, the expansion controller 408 signals the main processor 406 of the storage server 14 executing operating software that power down is safe and the operating software will power down the storage server 14.

The expansion controller can be a RAID controller card, can be embodied by storage server operating software, or a combination thereof.

For medical network 10 arrangements including one or more expansion modules 30a, 30b operatively connected with two storage server 14, a user interface 220, shown in FIG. 12, served by the storage server 14 to the 3-D imaging workstation 38 being operated by the user includes a “drives and temperatures” summary 222 indicating this arrangement. The storage server 14, each of the expansion modules 30a, 30b, and the SAS connections between each of the storage server 14 and expansion modules 30a, 30b are represented by full color icons 225. The previously grayed out icons 210 of FIG. 11 representing the expansion modules 30a, 30b are now active, being represented in full color. Again, each icon 224 representing hard drive unit provided to the storage server 14 and the expansion modules 30a, 30b can be color coded to indicate a status of each hard drive unit 38 according to the legend 215. Similarly, icons 226 are displayed adjacent to a status indicator 228 indicating the status quo of each of the SAS connections. And just as before, temperature indicators are displayed adjacent to each icon 225 representing the storage server 14 and the expansion modules 30a, 30b.

The user interface 220 can be automatically updated by the storage server 14 in response to the addition or removal of any components such as the expansion modules 30a, 30b to reflect the current configuration. Further, the sequential installation of the expansion modules 30a, 30b according to the SAS protocol enables the user interface 220 to identify expansion modules 30a, 30b that are physically connected but are experiencing functional difficulties rendering them unusable.

The storage server 14 can optionally also be employed within the medical network 10 to grant a referring physician controlled and secure access to medical output stored in the second storage server 16 which, in the present embodiment, is a PACS server associated with a medical care facility. For discussion of the present embodiment, the second storage server 16 will be referred to as the PACS server 16. Such an embodiment would be useful where the referring physician is not affiliated with the medical care facility whose medical output is stored on the PACS server 16. The referring physician may be a small entity that lacks the computer hardware and/or software resources required to access, retrieve and view medical output stored in a PACS server 16.

To grant the referring physician with access to medical output introduced to the storage server 14 to be subsequently stored on the PACS server 16, the storage server 14 can be configured to automatically route medical output for patients associated with the referring physician to a storage destination that the referring physician can access.

According to alternate embodiments, a profile for the referring physician can be established within the storage server 14, thereby granting the referring physician authority to login to the storage server 14 using a login ID and password. The login ID and password can be specific to the referring physician. Based on this login ID and password the storage server 14 can prohibit the referring physician from accessing medical output associated with patients not under the referring physician's care, while allowing the referring physician to access medical output for patients that are under the care of the referring physician. Newly-acquired medical output can optionally be stored by the storage server 14 in addition to being routed either automatically or manually to be stored in the PACS server 16. Additionally, the storage server 14 can be configured to perform a query-retrieve operation to retrieve existing medical output associated with a patient under the referring physician's care from the PACS server 16. For instance, the storage server 14 can query the PACS server 16 by submitting the referring physician's name as search criteria. Alternate environments can include submitting the names and/or IDs of patients known to be under the care of the referring physician to the PACS server 16 in an attempt to retrieve medical output associated with all patients of the referring physician. The query-retrieve operation can be performed periodically to keep the medical output associated with patients of the referring physician up to date, or can be triggered by any suitable triggering event such as the receipt of new medical output for an existing patient.

Once the medical output is stored by the storage server 14, the referring physician can access the storage server 14 through a website or a remote desktop connection to log in and gain access to only the medical output that the referring physician is rightfully entitled to view. Due to the sensitive nature of medical output and privacy concerns, the medical output can be maintained in encrypted format on the storage server 14, or can otherwise be secured to inhibit the ability of unauthorized parties to gain access to the medical output.

The storage server 14 can also be configured to conduct a query-retrieve operation in another context. For medical specialties such as mammography medical conditions are detected by comparing current medical output to previously-captured medical output. Thus, to properly diagnose such medical conditions a treating physician must have simultaneous access to both the current and the previous medical output for comparison. For the mammography example, the storage server 14 can be configured to automatically transmit a query-retrieve request to the PACS server 16, or any other storage location, for one or more historical mammograms associated with the same patient when a new mammogram is received for that patient by the storage server 14. The storage server 14 can be configured to automatically route, without human intervention, both the newly received mammogram and any historical mammograms returned by the query-retrieve operation to a storage destination to be used by the physician treating that patient such as the 3-D imaging workstation 18. This mammography example is merely illustrative, and the storage server 14 can be configured to automatically conduct a query-retrieve operation of any desired storage location in response to any predetermined triggering event. The results returned in response to the query-retrieve operation can optionally be automatically routed according to the parameters established under the SmartRouting tab 140 as explained above, or merely stored by the storage server 14 from where it can be retrieved.

According to alternate embodiments, a different storage server 14 can be deployed as an enterprise solution at a plurality of different facilities affiliated with the same health care provider. The storage server 14 at each of the different facilities can be utilized to perform any of the functions described herein. For example, the storage server 14 at one or more of the different facilities can be locally connected to a medical modality, such as MRI 12 for example, to store medical output from that medical modality. At other facilities, the storage server 14 can be operatively connected to communicate with a plurality of medical modalities over the communication network 22 and store the medical output from each of those modalities. According to the present embodiment the healthcare provider can also deploy a central storage server 14 at one of the facilities, or at another facility to be the central depository of the medical output received by each of the storage servers 14 disposed at the various different locations. The storage servers 14 located at each of the different facilities can optionally be configured using the SmartRouting tab 140 as explained above to automatically route all medical output received to the central storage server 14. Accordingly, each different facility can maintain a database of their own medical output locally, yet the healthcare provider also maintains a central storage server 14 with an archive of all medical output from each of the different locations.

According to alternate embodiments, a separate storage server 14 can optionally be provided at a plurality of different locations within the same facility. For example, in a large hospital there could be multiple CT modalities, multiple MRI modalities, in addition to a PET/CT modality. In this scenario, each individual modality can be operatively connected, either locally or remotely over the communication network 22, to it's own storage server 14. Other embodiments include a plurality, and optionally all of the CT modalities to be operatively connected to a common storage server 14 dedicated for CT medical output. Likewise, a plurality or all of the MRI modalities could be operatively connected to a common storage server 14 dedicated for MRI modalities, and the PET/CT modality can be operatively connected to send its medical output to a PET/CT storage server 14. Each of the different storage servers 14 can optionally be configured using the SmartRouting tab 140 discussed above to route, optionally automatically, all medical output received to a central storage server 14.

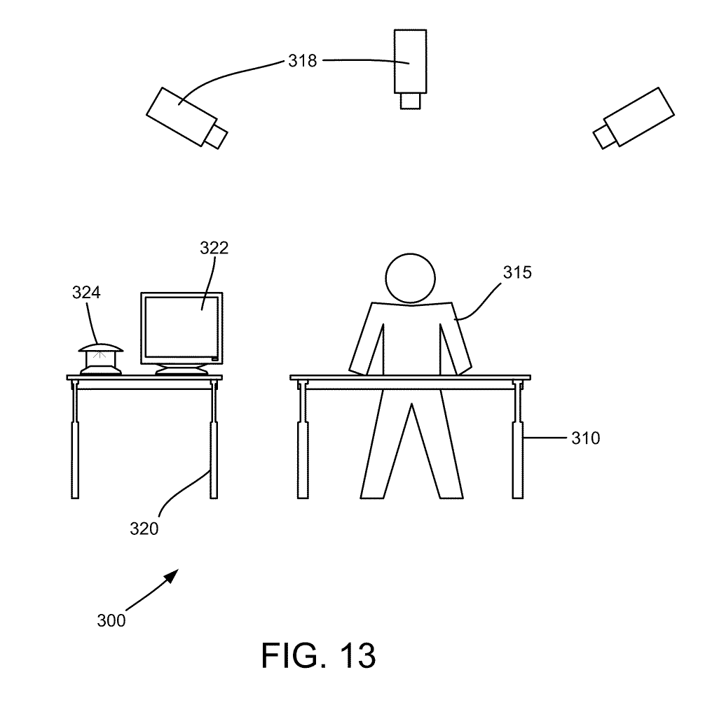

According to another embodiment, the storage server 14 or other computer-accessible storage device can optionally be utilized to receive, store, and manipulate medical data received from an image, video or other medical data capturing device and associate physician and/or patient information with that captured data to document a medical procedure. Such medical data can optionally be retrieved over the communication network 22, substantially in real time as the medical data is being captured, which can optionally include a WAN, LAN, local point-to-point communication link, or any combination thereof. An embodiment of an operating room 300, representative of any medical procedure area in which a medical procedure is to be performed on a patient, is schematically illustrated in FIG. 13. As shown, the operating room 300 includes an operating table 310 on which a patient can rest while a surgeon 315 performs a surgical procedure on the patient. An array of video cameras 318 can be oriented to capture video images of the surgeon 315, the patient resting on the operating table 310, and any other desired target that is to be the subject of captured motion video. Additionally, surgical equipment such as endoscopes and the like (not shown) can also optionally include a video camera for capturing motion picture video and still images within the patient during the surgical procedure. Although each of the cameras 318 described in this example capture motion picture video, the term cameras 318 is used illustratively herein as an example of any device that can capture any data related to the medical treatment of a patient, including devices for capturing still images within the operating room 300, a microphone for capturing audio within the operating room 300, a sensor such as a heart rate monitor for capturing a signal indicative of the patient's heart rate during the surgical procedure, or any other electric device for recording audio, video signals and/or still images within the operating room. Alternate embodiments include medical information capturing devices that can capture data other than audio/video signals, such as a cardiograph representing the functioning of a heart for example. However for the sake of brevity, the examples discussed below will include cameras 318 capturing digital video data.

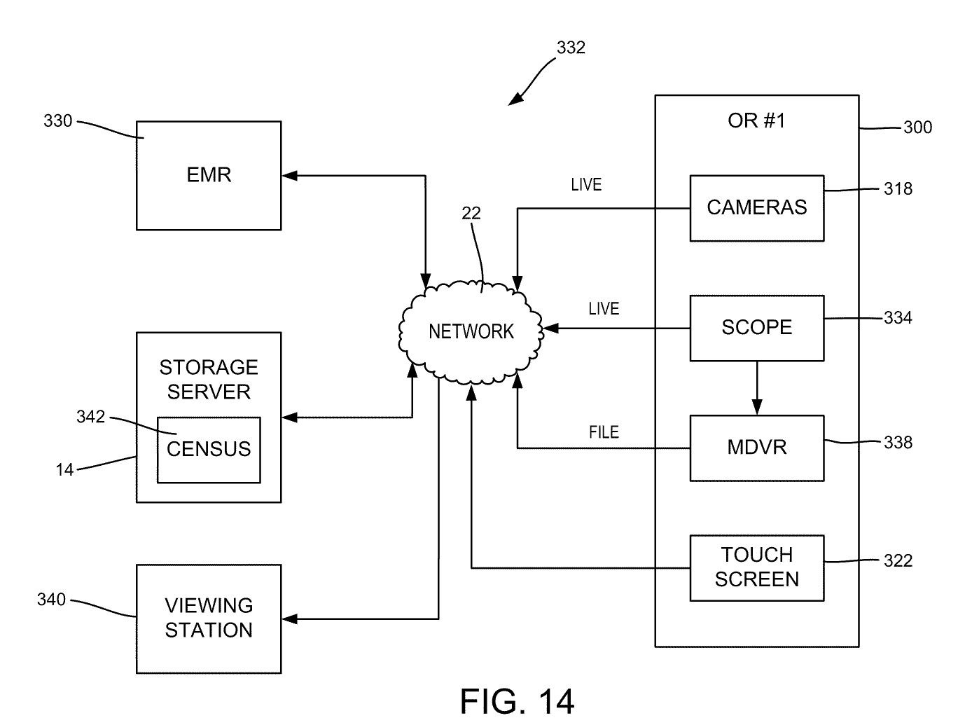

The operating room 300 shown in FIG. 13 also includes a separate table 320 on which rests a computer terminal including a touchscreen interface 322 operatively connected to a barcode reader 324. Instead of the table 320, a boom or pole suspended from the ceiling or extending from the wall or other object within the operating room 300 can be used to support the touchscreen interface 322, and optionally any other features within the operating room 300 described herein, above the floor of the operating room 300. For such embodiments the touchscreen interface 322 and other suspended objects can be moved aside to clear the floor of the operating room 300 to be cleaned following a surgical procedure. Alternative embodiments of the barcode reader 324 can include any computer-readable label reader such as a RFID tag reader, infrared reader, and the like, but for the sake of brevity the invention will be described herein as utilizing a barcode reader 324. The barcode reader 324 can be utilized at the outset of the surgical procedure to scan a barcode printed onto a wristband worn by the patient to uniquely identify the patient. In response to scanning the barcode on the patient's wristband or other machine readable identifier associated with the patient, one or more records retrieved from the stored server 14, an electronic medical record (“EMR”) database 330 (FIG. 14), any other electronic database accessible via the communication network 22, or any combination thereof are caused to be displayed by the touchscreen interface 322. A nurse, physician or other party in the operating room 300 can enter a command via the touchscreen interface 322 to confirm that the record returned and displayed on the touchscreen interface 322 is indeed associated with the patient that is to undergo a surgical procedure and whose barcode was scanned. If the displayed record does not match the patient, the party can scroll through and select the correct patient from other returned records or manually enter the proper information corresponding to the patient.

The touchscreen interface 322 can optionally be dedicated for the sole or primary purpose of confirming the identity of patients entering the operating room 300. According to alternate embodiments, the touchscreen interface 322 can optionally form a portion of an existing system present in the operating room 300 with a different primary purpose, such as a labeling system for generating labels to be applied to syringes and/or vials for storing anesthesiology or other substances to a patient as part of a surgical procedure. The touchscreen interface 322, like the barcode scanner 324, can transmit the information input over the communication network 22 (FIG. 14) to be received by the storage server 14. For example, information indicative of the identity of at least one of the patient and surgeon 315 or other treating physician can be input via the touchscreen interface 322. An association between this identifying information and the digital video data being captured by one or more of the cameras 318 can be created, optionally after the captured digital video data has been transmitted from the camera(s) 318, and optionally after the captured digital video data has been stored in the storage server 14 or other non-transitory computer-accessible storage device.

Other embodiments include the touchscreen interface 322 formed as part of one or more of the cameras 318. For such embodiments, the cameras 318 include a computer-processor based controller for executing computer-executable instructions that cause the cameras 318 to create an association between the video data being captured and at least one of the patient and surgeon 315 or other physician treating the patient. The captured digital video data can be transmitted from the cameras 318 already associated with at least one of the patient and surgeon 315 or other treating physician.

Instead of the touchscreen interface 322, other embodiments can include a conventional general-purpose computer terminal in the operating room 300 for entry of the information indicative of the patient and/or physician described herein. But regardless of the interface, a computer processor can execute and display a web-browser application or other suitable application allowing navigation of network-accessible resources. For example, the web-browser application can be an application that retrieves translates HTML or other formatted documents to be displayed in a graphical user interface (“GUI”). The GUI can display form fields in which the identifying information can be entered. However, for illustrative purposes, the embodiment employing a touchscreen interface 322 will be described in detail below.

FIG. 14 shows an alternate embodiment of the medical network 332 that can be utilized for processing the video data captured by the cameras 318, surgical equipment such as an endoscope 334, or any other capturing device in the operating room 300. Video data captured by the cameras 318 as well as the endoscope 334 or other video sources can be streamed in real-time over the communication network 22 to the storage server 14 or other suitable non-transitory storage location. The storage server 14 can also optionally be configured to forward the streamed real-time video to viewing devices on the communication network 22 so doctors, nurses, students or other healthcare providers can observe the video, substantially in real time as it is being recorded. A medical DVR (“MDVR”) 338 can also optionally be located within the operating room 300 or adjacent to the operating room 300 to locally record video data from the cameras 318 and/or endoscope 334 or other surgical device for redundancy, and to ensure accurate recording of the surgical procedure in the event that a disruption of the communication network 22 occurs. Instead of transmitting in real time to a desired network storage location, the MDVR can transmit complete files to such a desired storage location over the network 22 once they are fully recorded on the MDVR. The captured video data can optionally be transmitted over the communication network 22 to be stored on the storage server 14. The MDVR can also optionally be transmitted over the communication network 22 to be presented on a viewing station 340 to a limited audience as described in detail below. The viewing station 340 can be any presentation device than can accept digital video input such as a HDTV, computer monitor, projector, iPod, cellular telephone, or any other electronic device capable of reproducing video and/or still images.

The EMR 330 mentioned above is an electronic database maintaining electronic medical records for patients being seen by the healthcare provider. Patients arriving at a facility operated by, or on behalf of the healthcare provider can initially check-in and have their information entered into the EMR 330 before being treated. This information is stored in the EMR 330 and made accessible over the communication network 22 in a format that is standardized at least to the health care provider. The EMR 330 also transmits over the communication network 22 so-called admission/discharge/transfer (“ADT”) codes to be received by other network-connected devices for the purpose of updating the status of patients within the medical network 332. As the name implies, ADT codes can at least indicate whether a patient has been admitted, discharged or transferred within the healthcare provider. The storage server 14 can be configured to monitor the communication network 22 for the transmission of the ADT codes from the EMR 330. As the storage server 14 detects the ADT codes it records them in a database of patient census data 342 and associates the ADT codes with their respective patients. The database of ADT codes stored by the storage server 14 can optionally be made searchable, limited by the level of detail as transmitted by the EMR 330. Thus, storage server 14 can provide a useful interface for other network-connected devices that are not adapted to receive updates via the ADT codes, or are not compatible with the EMR 330. In alternate embodiments, the storage server 14 can optionally use the communication network 22 to directly access patient information on the EMR 330 and build the patient census data 342. Information concerning the patients can thus be retrieved from the storage server 14 instead of, or in addition to the EMR 330.

At the start of a surgical procedure the patient is transported to the operating room 300, where the barcode on the patient's wristband can be scanned using the barcode reader 324. Alternatively, the patient's initials, last name, date of birth, ID number or any other identifying information can be entered by a technician within the operating room 300 via the touchscreen interface 322. This information is transmitted over the communication network 22 to conduct a query of at least one of the EMR 330 and the storage server 14, including the census data 342, in an effort to retrieve a record associated with the patient on which the surgical procedure is to be performed. The results served by the storage server 14 and/or EMR 330 can be displayed in an order of decreasing likelihood of matching the patient on the touchscreen interface 322. The record displayed can optionally include a photograph or other unique identifying information of the patient for confirmation purposes. Regardless of how the patient's identity is confirmed, the technician operating the touchscreen interface 322 can input a command confirming the record displayed is associated with the patient. In the unlikely event no record can be found for the patient, a technician is presented with the option to manually enter identifying information about the patient via the touchscreen interface 322.

The touchscreen interface 322 can also allow the technician to search for and optionally confirm the identity of the surgeon 315 who is to conduct the surgical procedure. Again, the storage server 14 or other hosting computer can serve content over the communication network 22 to present an operator with a query tool for searching for an identity of the physician. Alternate embodiments can optionally seek to extract the identity of the surgeon 315 from the EMR 330 if available. Similar to confirmation of the patient's identity, the name of the surgeon can optionally be returned in response to scanning the barcode on the patient's wristband or manually identifying the patient or physician with the touchscreen interface 322. According to alternate embodiments, the technician can enter the surgeon's initials or scan the surgeon's ID badge or enter other identifying information via the touchscreen interface 322 to be used to conduct a query for the surgeon in an electronic database. Such a query can be conducted according to any suitable search protocol, such as the so-called lightweight directory access protocol (“LDAP”) for querying and modifying data of directory services implemented in Internet protocol (“IP”) networks. The search results returned in response to the selection data again present the technician with the option to confirm the identity of the surgeon before the surgical procedure is to begin.

The patient and/or surgeon information confirmed via the touchscreen interface 322 can be associated with the video data captured by the cameras 318 and the endoscope 334 as it is received by the storage server 14. The patient and/or surgeon information can optionally be associated with the video data as it is recorded by the MDVR 338, and can optionally be added to previously-recorded content received by the storage server 14 from the MDVR 338 or any other source. For embodiments including the cameras 318 equipped with the touchscreen interface 322 and processor, the association between the captured digital video data and the patient and/or surgeon 315 can be established by the camera(s) 318 prior to transmission of the captured digital video data to be recorded in a computer-accessible storage device such as the storage server 14. For other embodiments, the association is established once the video data has been transmission over the communication network 22 and stored in a desired storage location such as the storage server 14, for example. Regardless of when the association occurs, the video data can optionally be stored in a format compliant with a medical image communication standard, such as the DICOM standard for example, associated with at least one of the patient and the physician who was involved in the medical procedure. Combining the patient information with the video data in the storage server 14 can transform otherwise abstract video data into useful information that can be associated with a patient and a surgeon. The store server 14 can use the DICOM format as the electronic data representation for associating videos and images, with patient information and physician information.

It may be desirable to restrict access to recorded medical data, thereby limiting access to such medical data to those with predetermined authorization to view the medical data. For example, restricting the medical data can include requiring entry of a password when prompted during an attempt to gain access to the recorded medical data. Other embodiments can optionally require recorded medical data to be accessed via a user account associated with the physician involved in the medical procedure or other authorized party. Thus, the physician involved with the medical procedure or otherwise authorized to view recorded medical data to subsequently retrieve and view or otherwise observe the medical data stored on the non-transitory computer readable medium of the storage server 14. Another physician, such as someone who was not involved in the medical procedure, will be required to enter the password or other information indicative of authorization to view the medical data before being granted access to such recorded medical data.

According to alternate embodiments it may be desirable to transmit the video data being captured by the cameras 318 and/or the endoscope 334 to be displayed by the viewing station 340 or other presentation device that can reproduced the recorded medical data. For instance, a surgeon who is next in line to use the operating room 300 may wish to look in on the progress of the current surgical procedure being performed in the operating room 300 to get a sense of when the operating room 300 will become available. Another example includes transmitting the video data to a viewing station 340 in a classroom for educational purposes. In both of these examples it is desirable to broadcast the surgical procedure being performed but it is unnecessary to display all the video captured by the cameras 318 and the endoscope 334 because some video is not relevant or appropriate for viewing. To provide the audience with an indication of the nature of the surgical procedure being performed it may also be desirable to display contextual information on the viewing station 340 while the surgical procedure is underway. But for privacy purposes it may be desirable to conceal the identity of the patient and/or prevent private portions of the patient from being broadcast to avoid making the patient feel a sense of embarrassment or of having their privacy invaded.

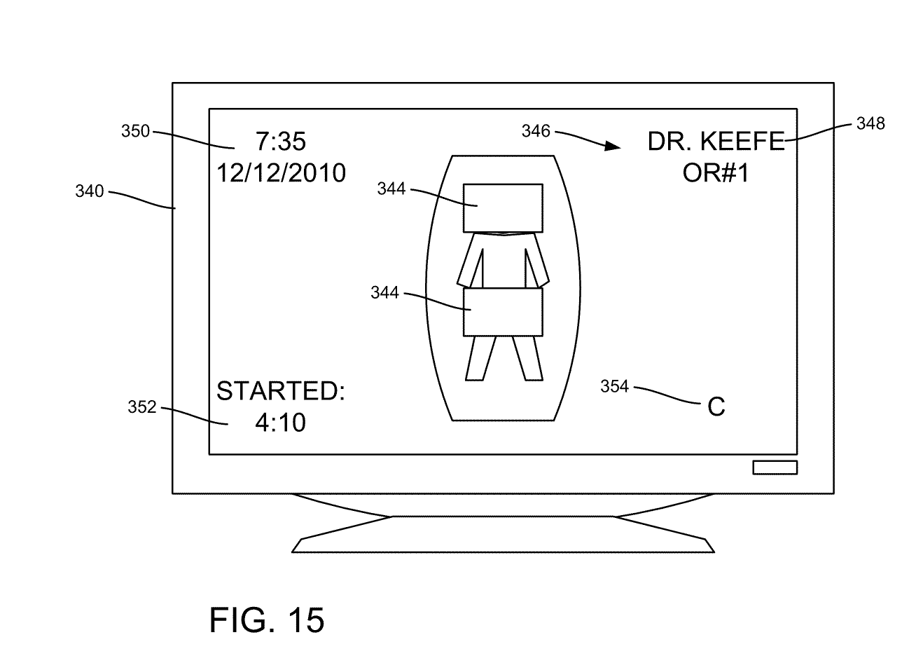

A processor provided to the storage server 14 can execute computer-executable instructions programmed therein to serve the recorded video data for viewing over the communication network 22, and can optionally generate a digital overlay that shields from view on the viewing station 340 portions of the surgical procedure that are not to be broadcast as illustrated in FIG. 15. FIG. 15 is an example of the viewing station 340 located in a physicians' lounge, for example, where the surgeon next in line to use the operating room 300 is waiting. As shown, the storage server 14 generates logical screens 344 that are overlaid onto the digital video data being displayed by the viewing station 340 to conceal the patient's face and genital area during the surgical procedure. However, since the logical screens 344 are digitally generated by the storage server 14 and overlaid onto the digital video data being displayed, the logical screens 344 are not recorded by the storage server 14 or embedded within the video data itself. In other words, should an unedited and uncensored version of the video data be required it can be retrieved from the storage server 14 without the logical screens 344.

The digital video data being transmitted over the communication network 22 from the cameras 318 and/or the endoscope 334 is displayed by the viewing station 340 in FIG. 15 along with contextual information 346 regarding at least one of the patient (e.g., patient's name), physician (e.g., physician's name), surgical procedure (e.g., a nature of the medical procedure), operating room identification information (e.g., name or location of operating room) and any combination thereof. Due to privacy concerns, however, alternate embodiments of the method can exclude from the transmission to be reproduced by the presentation device, or at least obscure the name or other information that can identify the identity of the patient. For the specific example illustrated in FIG. 15, however, the contextual information 346 includes a surgeon's name 348, a current time and date 350, and the starting time 352 of the surgical procedure being broadcast. The contextual information 346 also includes a progress indicator 354 indicating the current stage of the surgical procedure. As various milestones are reached during the surgical procedure, a technician within the operating room 300 can update the progress indicator 354 via the touchscreen interface 322. For example, when the patient meets the anesthesiologist or surgeon within the operating room 300 the technician within the operating room 300 can enter via the touchscreen interface 322 that the surgical procedure has reached “A” time. When the anesthesiologist administers the sleeping agent to the patient the surgical procedure is said to have reached “B” time, and this status update can be entered via the touchscreen interface 322. When the surgical procedure actually begins, it is said that “C” time has been reached, and again the status can be updated via the touchscreen interface 322. And finally, “D” time is reached once the patient is awake following completion of the surgical procedure. Thus, in FIG. 15 the progress indicator 354 that reads “C” indicates that the surgical procedure is underway but not yet completed. The specific use of letter codes is illustrative, and the progress indicator 354 can take on any form that allows a degree of completion to be determined by a viewer.

In addition to the video data transmitted internally over the communication network 22, the storage server 14 can also be utilized to store medical output, video data or other such medical information relating to the treatment of patients for each physician associated with the healthcare provider associated with the storage server 14. This medical information may be input to the storage server 14 from a source external of the medical network 332. But in order to limit access to a patient's medical information on the storage server 14 to only that patient's physician, the information on the storage server 14 is to be associated with the patient's physician. The medical information for each patient is stored in a secured manner on the storage server 14 to prevent parties other than each patient's own personal physician from accessing and viewing the medical information. Each physician can log into the storage server 14 using a user ID and password for authentication purposes. The user ID and password combination can be used by the storage server 14 to uniquely identify the physician and any medical information for patients affiliated with that physician, allowing the medical information to be viewed by the physician. Thus, medical information stored in the storage server 14 must be properly associated with a physician authorized to view that medical information to ensure that each physician has access to their medical information when logged in.

For internally-input medical information captured or generated within the medical network 332, such as the video data from the cameras 318 and/or endoscope 334 for example, the storage server 14 can require selection of a recognized physician, optionally from a menu on the touchscreen interface 322 that displays information from a pre-populated database on the storage server 14 before recording is permitted to begin. Once confirmation of the physician is received via the touchscreen interface 322 at the beginning of a surgical procedure, the video data recorded during that surgical procedure will be automatically associated with the physician in the storage server 14.

In contrast, medical information being input to the storage server 14 from an external source may not be accompanied by manual confirmation of the proper physician's identity. Under such circumstances the storage server 14 can automatically conduct a query using a portion of the medical information being imported in an attempt to automatically identify the proper physician from within an electronic database that is accessible to the storage server 14. A physician's name, or portion thereof, can be extracted from the medical information (such as from a DICOM header for example) and can be used to conduct a query during which it is compared against a database of aliases for each of the physicians to minimize the number of patients whose medical information cannot be automatically affiliated with the proper physician. However, for instances where there are no apparent matches or there is a potential conflict such as when two physicians having similar names work at the same healthcare provider, the medical information being input can be temporarily flagged as unassigned if a definitive match can not be made with reasonable certainty. Flagged medical information is stored in an “unassigned” folder within the storage server 14. Occasionally, an authorized operator is to log into the storage server 14 to resolve all flagged medical information in the unassigned folder and manually create the association between each patient and their physician. The authorized operator can be an administrator who is authorized to view the recorded medical video data to be associated with other physicians.

The medical information stored in the storage server 14 can be sizeable, requiring a significant amount of time to serve it over the communication network 22 to a computer terminal used by a physician to review the medical information. In an effort to streamline the distribution of medical information for review by physicians, the storage server 14 can optionally be configured to automatically, without user intervention, distribute medical information associated a physician's patient over the communication network 22 to be stored at a secure location on the physician's computer. For instance, a portion of medical information received by the storage server 14 can be used to query the database of physicians in an attempt to associate the medical information with the proper physician as described above. Other medical information, for example, body part, type of procedure or date of procedure, may also be associated with the proper physician when being stored in the storage server 14. For example, cardiologists may be returned as candidates to be associated with a cardiogram. In response to being associated with the proper physician, automatically at predetermined times, periodically, or based on network traffic volumes, medical information associated with a physician in the storage server 14 is encrypted or otherwise secured to be transmitted over the communication network 22 and stored within a secure location on the physician's computer terminal. An example of the secure location include a password-protected folder or other storage location. Each physician can optionally select automatic (i.e., without operator intervention) routing preferences, such as electing to auto route all recorded content, or flag content to be auto routed at a desired time.

Transmissions of the medical information over the communication network 22 to be received by each physician's respective computer terminal can be scheduled to occur at times when network traffic is predicted to be at or near a minimum. For example transmissions of the medical information can be scheduled to begin every night (or other frequency) beginning at 1:00 a.m. According to alternate embodiments, the medical information can be transmitted to the proper physicians depending upon a usage of physicians on personal computer. During times of inactivity, the physician's computer terminal (e.g., home or office computer) can be programmed to submit a request of the storage server 14 over the communication network 22 to initiate transmission of the medical information. Alternately, an account for each physician can be maintained with the physicians' preferences on the storage server 14 or other network-connected device. When the physician begins to actively use the receiving computer terminal, at which time the transmission is interrupted, or at least slowed to a slower rate than the rate at which the medical information was being transferred during the period of inactivity. According to alternate embodiments, the storage server 14 can employ bandwidth throttling to limit the rate at which the medical information is transmitted over the communication network 22 to be received by the physician's computer terminal.

Medical information transmitted over the communication network 22 to each physician's computer terminal can be designated by a configuration file on the physician's computer terminal to be handled in a predetermined manner by the physician's computer terminal according to input from the physician, or based on the nature of the medical information. For instance, the configuration file can assign a “Save Permanently” designation to certain medical information that is received. Medical information marked Save Permanently is to be received by the physician's computer terminal and remain in a secure storage location until the physician manually deletes it. Similarly, the storage server 14 can assign medical information a “Save Until X” designation. X can be any desired length of time such as 7 days, 30 days, 60 days, 90 days, one year, etc. . . . during which time the medical information is to remain locally stored on the physician's computer terminal, after which it is automatically marked for deletion. The physician can also mark received medical information as having been read, and delete. Read medical information, if not marked Save Permanently or Save for X, can be written over when there is no more available storage for receiving new medical information. Medical information marked delete is also available to be immediately written over with new medical information. Unread medical information on the physician's computer terminal will remain there, and will not be overwritten with new medical information until it is read, assuming the physician does not designate it for deletion.

In addition to being stored in a secure location on the physician's computer terminal, the medical information can be delivered with an application that is operable on the physician's computer terminal to automatically secure the medical information in response to a predetermined period of inactivity. For example, the physician initially gains access to the secure location storing the medical information using a username and password combination that unlocks the secure location and grants access to the medical information. Once the medical information is open and available for viewing on the physician's computer terminal, access to the medical information will once again become restricted after 10 minutes (or other specified time period) of inactivity. The physician's computer terminal interprets this inactivity as the physician walking away from the computer terminal, leaving the medical information vulnerable to being viewed by an unauthorized party. To regain access to the medical information after access once again becomes restricted the physician will be required to reenter the username and password initially used to gain access to the medical information in the first place.

Any of the configurations of the physicians' computer terminals discussed herein can be configured by an administrator or authorized operator from the storage server 14 using the communication network 22. Configuration parameters can be entered by an administrator with access to the storage server 14. The configuration parameters established by the administrator are to be pushed, or alternately requested by the physicians' computer terminals, over the communication network 22 and delivered to each intended physician's computer terminal. The configuration parameters received by the computer terminals are interpreted and the local settings of the computer terminal are updated to reflect the configuration parameters. Thus, the administrator can remotely configure each physician's computer terminal according to the physician's preferences and the policies of the health care provider. To configure remotely-located computer terminals, the administrator can simply develop the configuration parameters at a computer terminal and transmit the configuration parameters over the communication network 22 to be received by the storage server 14, from where they are passed along to the intended physician's computer terminal. Likewise, the physician can modify their own configuration settings when authorized to do so by the health care provider, and those changes will automatically be uploaded by the storage server 14 when the next communication is initiated over then communication network 22.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used herein, such term is intended to be inclusive in a manner similar to the term “comprising” as “comprising” is interpreted when employed as a transitional word in a claim.

What is claimed is:

1. A method of documenting a medical procedure, the method comprising:
receiving medical data captured during the medical procedure to be documented;
receiving information indicative of an identity of at least one of a patient that is a subject of the medical procedure and a physician involved with the medical procedure;
storing the medical data in a non-transitory computer readable medium associated with the at least one of the patient and the physician;
restricting access to the medical data, wherein said restricting allows the physician involved with the medical procedure to subsequently retrieve the medical data stored in the non-transitory computer readable medium and view the medical data retrieved, and prevents another physician from viewing the medical data without entering information indicative of authorization to view the medical data.

2. The method according to claim 1 further comprising transmitting the medical data over the communication network to be reproduced by a presentation device for audience.

3. The method according to claim 2 further comprising transmitting contextual information to be presented to the audience with the medical data.

4. The method according to claim 3, wherein the medical procedure is conducted in a medical procedure area, and the presentation device is remotely located and external to the medical procedure area.

5. The method according to claim 4, wherein the contextual information comprises at least one of: a patient name, location of the medical procedure, a current time of the medical procedure, a date of the medical procedure, a start time of the medical procedure, an identification of the physician involved with the medical procedure, an indication of a nature of the medical procedure, and a progress indicator.

6. The method according to claim 2 further comprising transmitting content for generating an overlay to shield a portion of the medical data from view by the audience.

7. The method according to claim 6, wherein the overlay comprises a computer-generated image that conceals the portion of the medical data from view, wherein the computer-generated image is not embedded in the medical data stored in the non-transitory computer readable medium.

8. The method according to claim 2, wherein a position of the overlay over the medical data is selectable by an operator.

9. The method according to claim 2 further comprising excluding a patient name from the medical data to be reproduced by the presentation device for the audience.

10. The method according to claim 1, wherein said storing the medical data is captured with a medical data recording device, said method further comprising:
receiving an association between the medical data and the at least one of the patient and the physician established and transmitted by a recording device used to capture the medical data; and
storing the medical data associated with the at least one of the patient and physician.

11. The method according to claim 1, wherein said receiving the association comprises:
receiving, at a storage server comprising a network-accessible computer readable medium, the medical data;
separately receiving, at the storage server, information indicative of the identity of the at least one of the patient and the physician to be associated with the medical data; and
establishing at the storage server, an association between the medical data and the at least one of the patient and the physician.

12. The method according to claim 1, wherein said storing the medical data comprises storing the medical data in compliance with a standardized medical image format.

13. The method according to claim 12, wherein the standardized medical image format is a DICOM standard.

14. The method according to claim 1 further comprising serving content to an interface for presenting an operator with a query tool for searching for an identity of the patient.

15. The method according to claim 14, wherein the query tool is to search a database of electronic medical records associated with patients receiving medical care at a health care facility using data input by the operator via the interface.

16. The method according to claim 1 further comprising serving content to an interface for presenting an operator with a query tool for searching for an identity of the physician.

17. The method according to claim 16 further comprising:
receiving selection data input entered by the operator via the interface;
returning at least one possible matching physician corresponding to the selection data; and
receiving confirmation of the identity of the physician from the operator entered via the interface.
